(19) United States
(12) Patent Application Publication
(10) Pub. No.: US 2025/0330566 A1
(43) Pub. Date: Oct. 23, 2025

(54) METHOD, APPARATUS, AND MEDIUM FOR VIDEO PROCESSING

(71) Applicants: Douyin Vision Co, Ltd., Beijing (CN); Bytedance Inc., Los Angeles, CA (US)

(72) Inventors: Zhipin DENG, Beijing (CN); Li ZHANG, Los Angeles, CA (US); Kai ZHANG, Los Angeles, CA (US)

(21) Appl. No.: 19/258,830

(22) Filed: Jul. 2, 2025

Related U.S. Application Data
(63) Continuation of application No. PCT/CN2023/142517, filed on Dec. 27, 2023.

(30) Foreign Application Priority Data
Jan. 3, 2023 (WO) PCT/CN2023/070206

(51) Int. Cl. H04N 19/103; H04N 19/176

(52) U.S. Cl. CPC H04N 19/103; H04N 19/176

(57) ABSTRACT

Embodiments of the present disclosure provide a solution for video processing. A method for video processing is proposed. The method comprises: determining, for a conversion between a current video block of a video and a bitstream of the video, a prediction for the current video block based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and performing the conversion based on the prediction.

### CROSS REFERENCE TO RELATED APPLICATIONS

This application is a continuation of International Application No. PCT/CN2023/142517, filed on Dec. 27, 2023, which claims the benefit of International Application No. PCT/CN2023/070206, filed on Jan. 3, 2023. The entire contents of these applications are hereby incorporated by reference in their entireties.

### FIELDS

Embodiments of the present disclosure relates generally to video processing techniques, and more particularly, to geometric partition.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a prediction for the current video block based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and performing the conversion based on the prediction.

According to the method in accordance with the first aspect of the present disclosure, the current video block is coded with a GPM based mode or a CIIP based mode, and a prediction for the current video block is determined based on a plurality of blending schemes. Compared with the convention solution where only one blending scheme is available, the proposed method can advantageously employ one or more of the plurality of blending schemes adaptively, and thus improve the coding quality.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a prediction for a current video block of the video based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and generating the bitstream based on the prediction.

In a fifth aspect, a method for storing a bitstream of a video is proposed. The method comprises: determining a prediction for a current video block of the video based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; generating the bitstream based on the prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of intra prediction modes;

FIG. 5A illustrates a schematic diagram of top references;

FIG. 5B illustrates a schematic diagram of left references;

FIG. 6 illustrates a schematic diagram of discontinuity in case of directions beyond 45°;

FIG. 7A illustrates a schematic diagram of the definition of samples used by PDPC applied to diagonal top-right intra mode;

FIG. 7B illustrates a schematic diagram of the definition of samples used by PDPC applied to diagonal bottom-left intra mode;

FIG. 7C illustrates a schematic diagram of the definition of samples used by PDPC applied to adjacent diagonal top-right intra mode;

FIG. 7D illustrates a schematic diagram of the definition of samples used by PDPC applied to adjacent diagonal bottom-left intra mode;

FIG. 8 illustrates example diagram of four reference lines neighboring to a prediction block;

FIG. 9A illustrates an example of sub-partitions depending on the block size;

FIG. 9B illustrates a further example of sub-partitions depending on the block size;

FIG. 10 illustrates a schematic diagram of matrix weighted intra prediction process;

FIG. 11 illustrates spatial GPM candidates;

FIG. 12 illustrates GPM template;

FIG. 13 illustrates GPM blending;

FIG. 14 illustrates a schematic diagram of positions of spatial merge candidates;

FIG. 15 illustrates a schematic diagram of candidate pairs considered for redundancy check of spatial merge candidates;

FIG. 16 illustrates a schematic diagram of motion vector scaling for temporal merge candidate, C₀ and C₁;

FIG. 17 illustrates a schematic diagram of candidate positions for temporal merge candidates;

FIG. 18 illustrates schematic diagrams of MMVD search point;

FIG. 19 illustrates a schematic diagram of an extended CU region used in BDOF;

FIG. 20 illustrates a schematic diagram of an illustration for symmetrical MVD mode;

FIG. 21 illustrates a decoding side motion vector refinement;

FIG. 22 illustrates a schematic diagram of top and left neighboring blocks used in CIIP weight derivation;

FIG. 23 illustrates a schematic diagram of examples of the GPM splits grouped by identical angles;

FIG. 24 illustrates a schematic diagram of uni-prediction MV selection for geometric partitioning mode;

FIG. 25 illustrates a schematic diagram of exemplified generation of a bending weight w₀ using geometric partitioning mode;

FIG. 26 illustrates a schematic diagram of a low-frequency non-separable transform (LFNST) process;

FIG. 27 illustrates examples of SBT position, type and transform type;

FIG. 28 illustrates examples of the ROI for LFNST16;

FIG. 29 illustrates examples of the ROI for LFNST8;

FIG. 30 illustrates a schematic diagram of a discontinuity measure;

FIG. 31A illustrates a schematic diagram of an example of blending two partitions of a CU in accordance with embodiments of the present disclosure;

FIG. 31B illustrates a schematic diagram of an example of blending two top templates in accordance with embodiments of the present disclosure;

FIG. 31C illustrates examples of a blending area width and a ramp function for weights derivation;

FIG. 32 illustrates a flowchart of a method for video processing in accordance with embodiments of the present disclosure;

FIG. 33A illustrates an example of blending two partitions in accordance with embodiments of the present disclosure;

FIG. 33B illustrates a further example of blending two partitions in accordance with embodiments of the present disclosure;

FIG. 33C illustrates a still further example of blending two partitions in accordance with embodiments of the present disclosure; and

FIG. 34 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

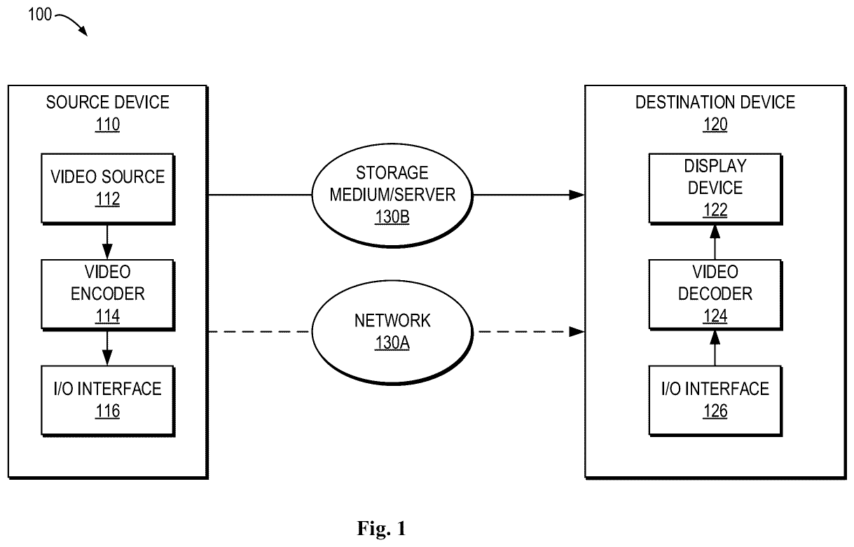

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

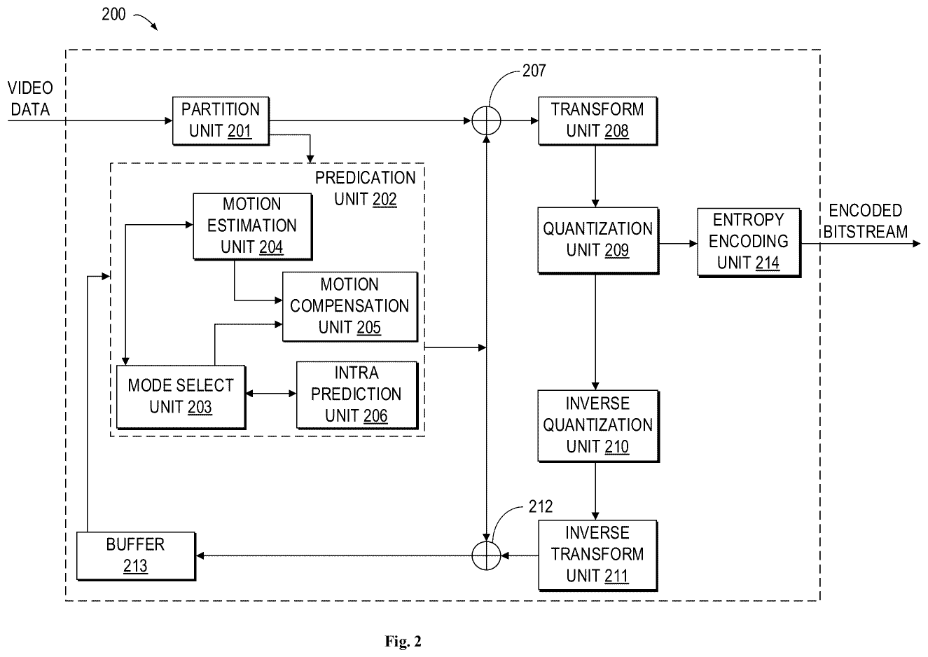

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

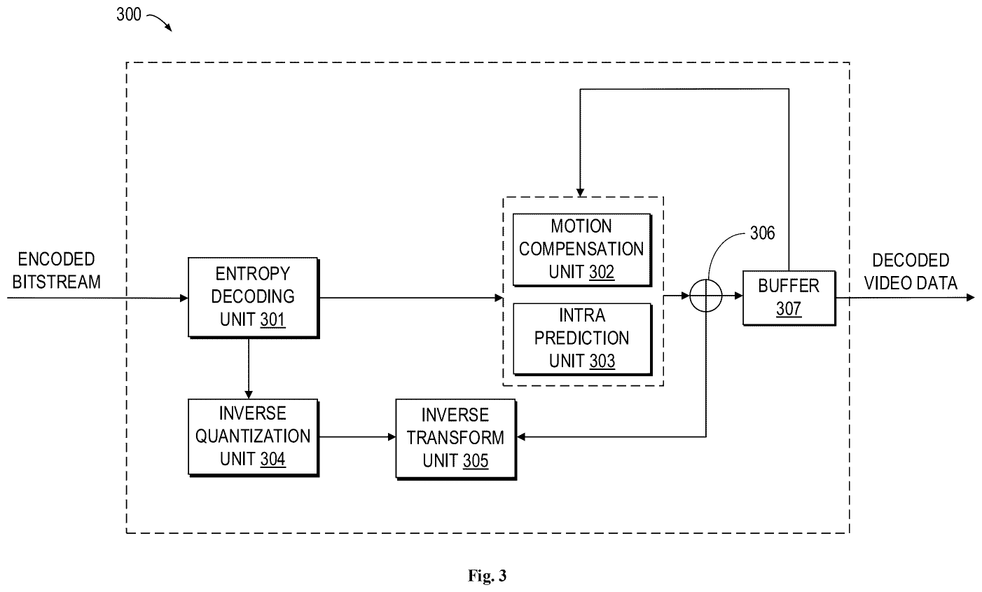

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about geometric partitioning and related techniques in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Existing Coding Tools

### 2.1.1. Intra Prediction

2.1.1.1. Intra Mode Coding with 67 Intra Prediction Modes

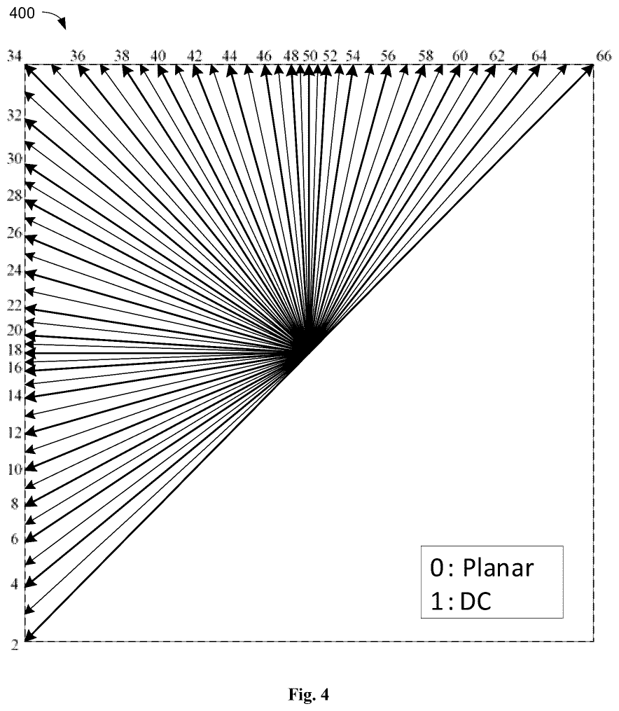

To capture the arbitrary edge directions presented in natural video, the number of directional intra modes in VVC is extended from 33, as used in HEVC, to 65. The new directional modes not in HEVC are depicted as dotted arrows in FIG. 4, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.1.1.2. Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes;
Neighbouring intra modes;
Derived intra modes.

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}.
If one of modes Left and Above is angular mode, and the other is non-angular:
   Set a mode Max as the larger mode in Left and Above,
   MPM list→{Planar, Max, DC, Max−1, Max+1, Max−2}.
If Left and Above are both angular and they are different:
   Set a mode Max as the larger mode in Left and Above,
   if the difference of mode Left and Above is in the range of 2 to 62, inclusive
      MPM list→{Planar, Left, Above, DC, Max−1, Max+1}.
   Otherwise
      MPM list→{Planar, Left, Above, DC, Max−2, Max+2}.
If Left and Above are both angular and they are the same:
   MPM list→{Planar, Left, Left−1, Left+1, DC, Left−2}.

Besides, the first bin of the mpm index codeword is CABAC context coded. In total three contexts are used, corresponding to whether the current intra block is MRL enabled, ISP enabled, or a normal intra block. During 6 MPM list generation process, pruning is used to remove duplicated modes so that only unique modes can be included into the MPM list. For entropy coding of the 61 non-MPM modes, a Truncated Binary Code (TBC) is used.

### 2.1.1.3. Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

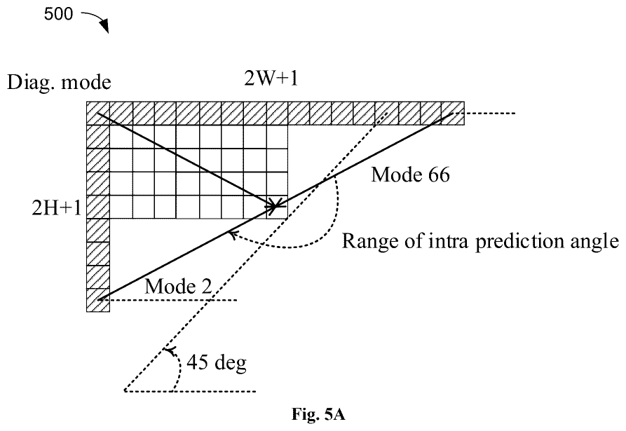

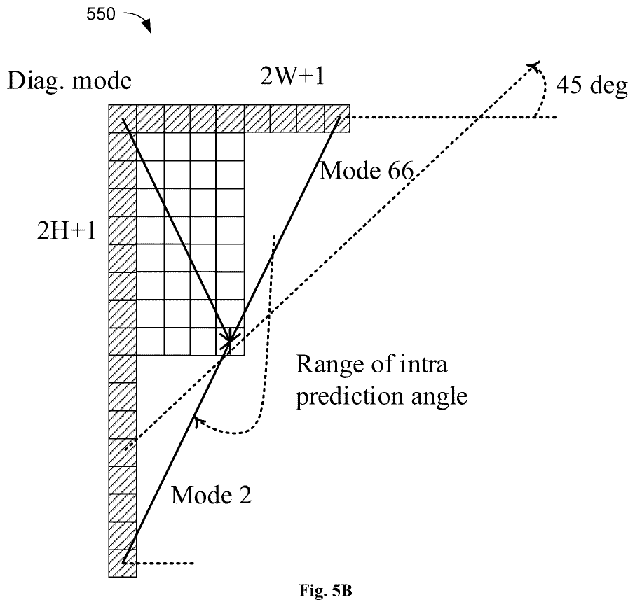

To support these prediction directions, the top reference with length 2W+1, and the left reference with length 2H+1, are defined as shown in FIGS. 5A and 5B, which illustrate reference samples for wide-angular intra prediction.

The number of replaced modes in wide-angular direction mode depends on the aspect ratio of a block. The replaced intra prediction modes are illustrated in Table 2-1.

TABLE 2-1
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

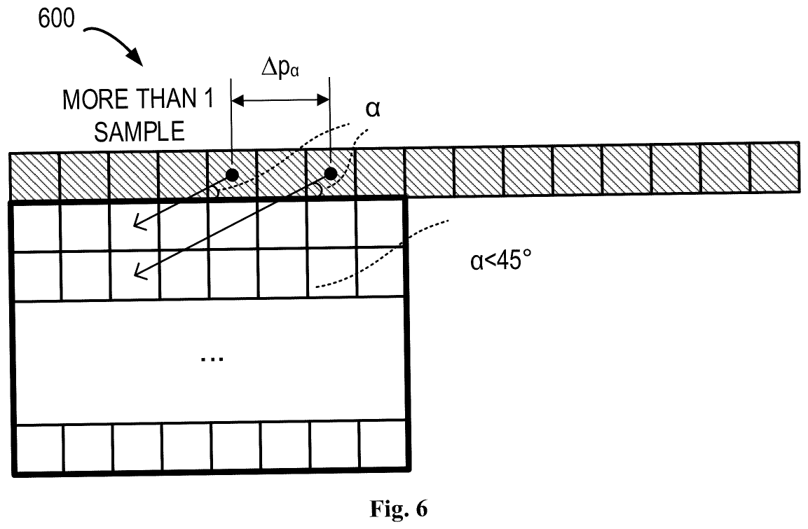

FIG. 6 illustrates a schematic diagram of discontinuity in case of directions beyond 45°. As shown in FIG. 6, two vertically-adjacent predicted samples may use two non-adjacent reference samples in the case of wide-angle intra prediction. Hence, low-pass reference samples filter and side smoothing are applied to the wide-angle prediction to reduce the negative effect of the increased gap Δpₐ. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes. In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore chroma DM derivation table for 4:2:2: chroma format is updated by replacing some values of the entries of the mapping table to convert prediction angle more precisely for chroma blocks.

### 2.1.1.4. Mode Dependent Intra Smoothing (MDIS)

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, simplified 6-bit 4-tap Gaussian interpolation filter is used for only directional intra modes. Non-directional intra prediction process is unmodified. The selection of the 4-tap filters is performed according to the MDIS condition for directional intra prediction modes that provide non-fractional displacements, i.e. to all the directional modes excluding the following: 2, HOR_IDX, DIA_IDX, VER_IDX, 66.

Depending on the intra prediction mode, the following reference samples processing is performed:
The directional intra-prediction mode is classified into one of the following groups:
   vertical or horizontal modes (HOR_IDX, VER_IDX),
   diagonal modes that represent angles which are multiple of 45 degree (2, DIA_IDX, VDIA_IDX),
   remaining directional modes;
If the directional intra-prediction mode is classified as belonging to group A, then then no filters are applied to reference samples to generate predicted samples;
Otherwise, if a mode falls into group B, then a [1, 2, 1] reference sample filter may be applied (depending on the MDIS condition) to reference samples to further copy these filtered values into an intra predictor according to the selected direction, but no interpolation filters are applied;
Otherwise, if a mode is classified as belonging to group C, then only an intra reference sample interpolation filter is applied to reference samples to generate a predicted sample that falls into a fractional or integer position between reference samples according to a selected direction (no reference sample filtering is performed).

### 2.1.1.5. Position Dependent Intra Prediction Combination

In VVC, the results of intra prediction of DC, planar and several angular modes are further modified by a position dependent intra prediction combination (PDPC) method. PDPC is an intra prediction method which invokes a combination of the un-filtered boundary reference samples and HEVC style intra prediction with filtered boundary reference samples. PDPC is applied to the following intra modes without signalling: planar, DC, horizontal, vertical, bottom-left angular mode and its eight adjacent angular modes, and top-right angular mode and its eight adjacent angular modes.

The prediction sample pred (x′y′) is predicted using an intra prediction mode (DC, planar, angular) and a linear combination of reference samples according to the Equation 3-8 as follows:

$$pred ( {x}^{′} , {y}^{′} ) = ( wL \times {R}_{- 1 , {y}^{′}} + wT \times {R}_{{x}^{′} , - 1} wTL \times {R}_{- 1 , - 1} + ( 64 - wL - wT + wTL ) \times pre d ( {x}^{′} , {y}^{′} ) + 32 ) >> 6 \qquad ( 2 - 1 )$$

where R_{x,-1}, R_{-1,y} represent the reference samples located at the top and left boundaries of current sample (x, y), respectively, and R_{-1,-1} represents the reference sample located at the top-left corner of the current block.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical and clipping operation is avoided. For angular modes, pdpc scale factor is adjusted such that range check is not needed and condition on angle to enable pdpc is removed (scale>=0 is used). In addition, PDPC weight is based on 32 in all angular mode cases. The PDPC weights are dependent on prediction modes and are shown in Table 2-2. PDPC is applied to the block with both width and height greater than or equal to 4.

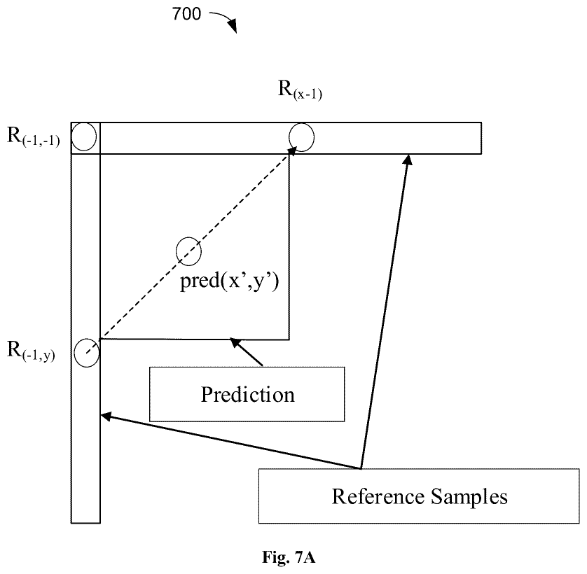

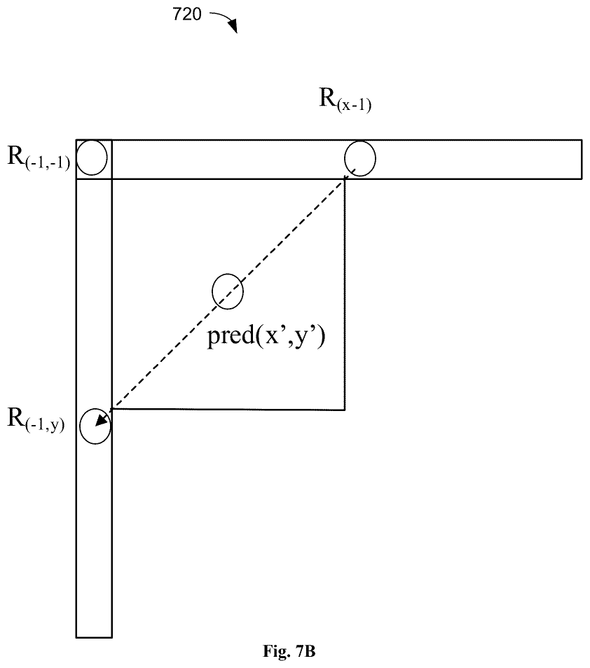

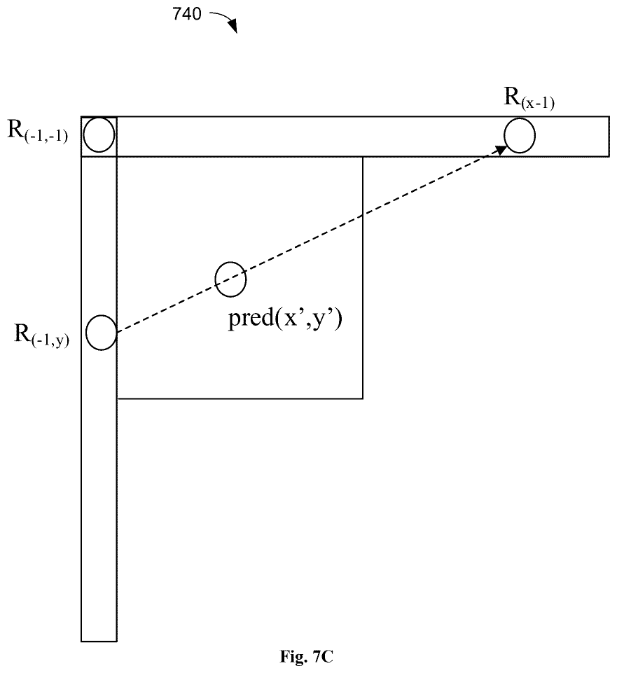

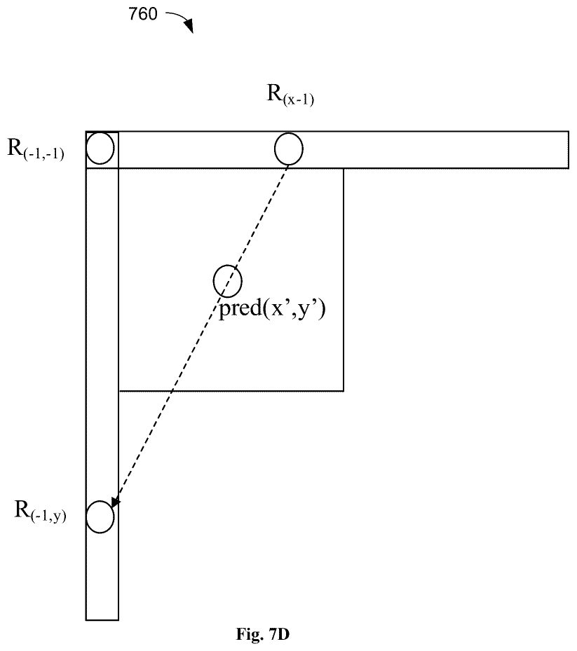

FIGS. 7A-7D illustrate the definition of reference samples (R_{x,-1}, R_{-1,y} and R_{-1,-1}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other annular mode, the reference samples R_{x,-1} and R_{-1,y} could be located in fractional sample position. In this case, the sample value of the nearest integer sample location is used.

TABLE 2-2
Example of PDPC weights according to prediction modes

| Prediction modes | wT | wL | wTL |
|---|---|---|---|
| Diagonal top-right | 16 >> ((y′ << | 16 >> ((x′ << | 0 |
| | 1) >> shift) | 1) >> shift) | |
| Diagonal | 16 >> ((y′ << | 16 >> ((x′ << | 0 |
| bottom-left | 1) >> shift) | 1) >> shift) | |
| Adjacent diagonal | 32 >> ((y′ << | 0 | 0 |
| top-right | 1) >> shift) | | |
| Adjacent diagonal | 0 | 32 >> ((x′ << | 0 |
| bottom-left | | 1) >> shift) | |

### 2.1.1.6. Multiple Reference Line (MRL) Intra Prediction

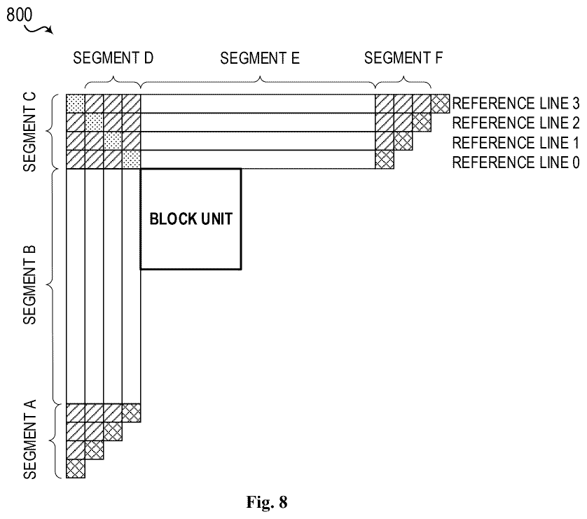

Multiple reference line (MRL) intra prediction uses more reference lines for intra prediction. In FIG. 8, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its downsampling filters. The definition of MLR to use the same 3 lines is aligned as CCLM to reduce the storage requirements for decoders.

### 2.1.1.7. Intra Sub-Partitions (ISP)

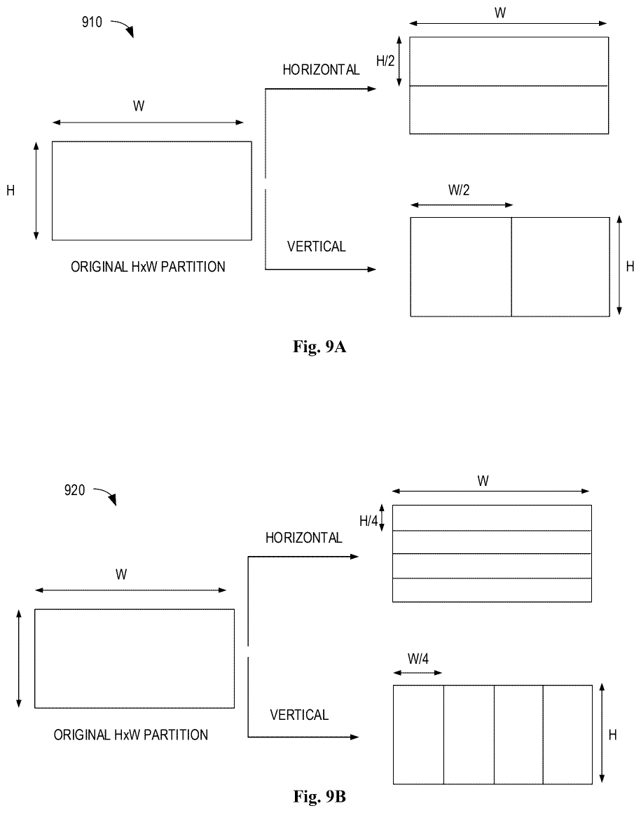

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding M/2×64 chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 9A and 9B shows examples of the two possibilities. FIG. 9A illustrates examples of sub-partitions for 4×8 and 8×4 CUs, and FIG. 9B illustrates examples of sub-partitions for CUs other than 4×8, 8×4 and 4×4. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used.

Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-3
Entropy coding coefficient group size

| | Coefficient |
|---|---|
| Block Size | group Size |
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
MPM usage: the MPM flag will be inferred to be one in a block coded by ISP mode, and the MPM list is modified to exclude the DC mode and to prioritize horizontal intra modes for the ISP horizontal split and vertical intra modes for the vertical one.
Transform size restriction: all ISP transforms with a length larger than 16 points uses the DCT-II.
PDPC: when a CU uses the ISP coding mode, the PDPC filters will not be applied to the resulting sub-partitions.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let ty and ty be the horizontal and the vertical transforms selected respectively for the w x h sub-partition, where w is the width and h is the height. Then the transform is selected according to the following rules:
If w=1 or h=1, then there is no horizontal or vertical transform respectively.
If w=2 or w>32, t_{H}=DCT-II.
If h=2 or h>32, t_{V}=DCT-II.
Otherwise, the transform is selected as in Table 2-4.

TABLE 2-4
Transform selection depends on intra mode

| Intra mode | t_{H} | t_{V} |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

In ISP mode, all 67 intra modes are allowed. PDPC is also applied if corresponding width and height is at least 4 samples long. In addition, the condition for intra interpolation filter selection doesn't exist anymore, and Cubic (DCT-IF) filter is always applied for fractional position interpolation in ISP mode.

### 2.1.1.8. Matrix Weighted Intra Prediction (MIP)

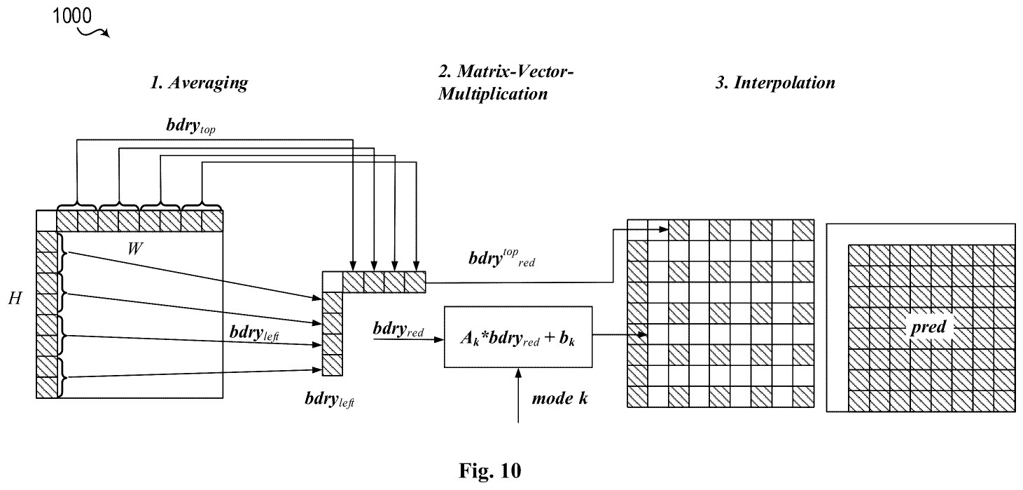

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 10.

### Averaging Neighboring Samples

Among the boundary samples, four samples or eight samples are selected by averaging based on block size and shape. Specifically, the input boundaries bdry^{top} and bdry^{left} are reduced to smaller boundaries

$${bdry}_{red}^{top} and {bdry}_{red}^{left}$$

by averaging neighboring boundary samples according to predefined rule depends on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows.

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix} . \qquad ( 2 - 2 )$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 3 )$$

$${H}_{red} = \{ \begin{matrix}4 & for max ( W , H ) \leq 8 \\ min ( H , 8 ) & for max ( W , H ) > 8\end{matrix} \qquad ( 2 - 4 )$$

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W,H) as follows:

$$idx ( W , H ) = \{ \begin{matrix}0 & for W = H = 4 \\ 1 & for max ( W , H ) = 8 \\ 2 & for max ( W , H ) > 8\end{matrix} . \qquad ( 2 - 5 )$$

Here, each coefficient of the matrix A is represented with 8 bit precision. The set S₀ consists of 16 matrices

$${A}_{0}^{i} ,$$

i∈{0, . . . , 15} each of which has 16 rows and 4 columns and 16 offset vectors

$${b}_{0}^{i} ,$$

i∈{0, . . . , 16} each of size 16. Matrices and offset vectors of that set are used for blocks of size 4×4. The set S₁ consists of 8 matrices

$${A}_{1}^{i} ,$$

i∈{0, . . . , 7}, each of which has 16 rows and 8 columns and 8 offset vectors

$${b}_{1}^{i} ,$$

i∈{0, . . . , 7} each of size 16. The set S₂ consists of 6 matrices

$${A}_{2}^{i} ,$$

i∈{0, . . . , 5}, each of which has 64 rows and 8 columns and of 6 offset vectors

$${b}_{2}^{i} ,$$

i∈{0, . . . , 5} of size 64.

### Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

Signaling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signaled. For an MIP mode, a transposed flag (isTransposed), which determines whether the mode is transposed, and MIP mode Id (modeId), which determines which matrix is to be used for the given MIP mode is derived as follows.

$$\begin{matrix}isTransposed = preModeIntra \& 1 \\ modeId = predModeIntra ≫ 1\end{matrix} \qquad ( 2 - 6 )$$

MIP coding mode is harmonized with other coding tools by considering following aspects:
LFNST is enabled for MIP on large blocks. Here, the LFNST transforms of planar mode are used.
The reference sample derivation for MIP is performed exactly as for the conventional intra prediction modes.
For the upsampling step used in the MIP-prediction, original reference samples are used instead of downsampled ones.
Clipping is performed before upsampling and not after upsampling.
MIP is allowed up to 64×64 regardless of the maximum transform size.
The number of MIP modes is 32 for sizeId=0, 16 for sizeId=1 and 12 for sizeId=2.

### 2.1.1.9. Spatial GPM (SGPM)

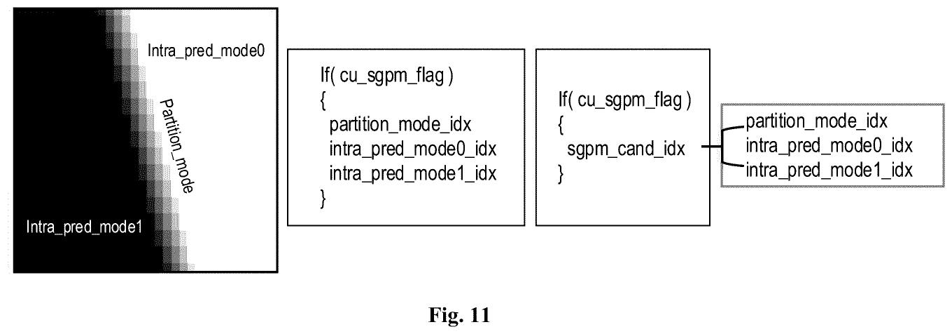

In spatial GPM, a candidate list is built which includes partition split and two intra prediction modes. Up to 11 MPMs of intra prediction modes are used to form the combinations, the length of the candidate list is set equal to 16. The selected candidate index is signalled. FIG. 11 illustrates spatial GPM candidates.

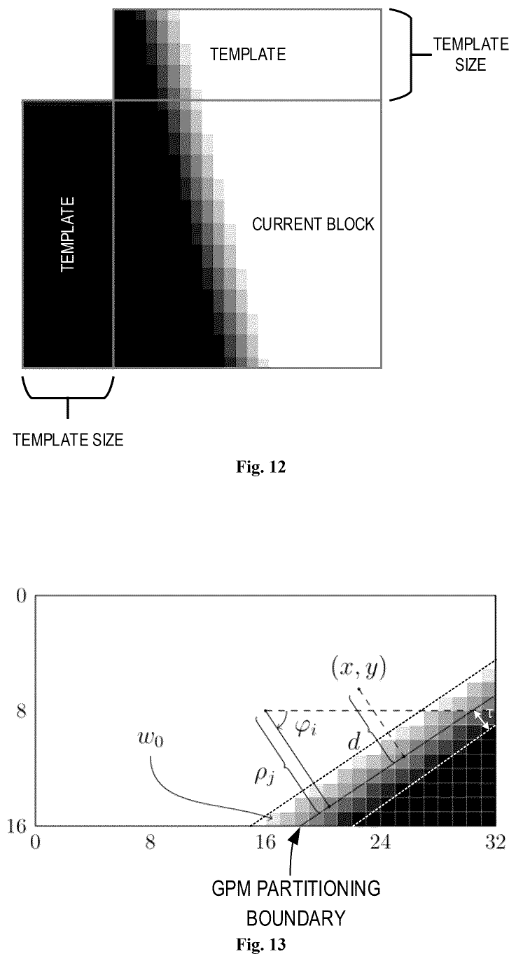

The list is reordered using template shown in FIG. 12. GPM blending process is not used in the template, and SAD between the prediction and reconstruction of the template is used for ordering. FIG. 13 illustrates GPM blending.

The SGPM mode is applied to blocks whose width and height meet the same restrictions as in inter GPM. The following items are considered:
Spatial GPM partition modes:
   26 predefined modes,
   Adaptive derivation algorithm based on the horizontal and vertical gradients ratio.
Intra prediction mode selection:
   IPM list with and without TIMD:
      For each partition mode, an IPM list is derived for each part using intra-inter GPM list derivation. The IPM list size is 3. In the list, TIMD derived mode is replaced by 2 derived modes with horizontal and vertical orientations (using top or left templates) or TIMD derived mode is excluded.
   MPM list:
      A uniform MPM list, up to 11 elements, is used for all partition modes.
Template size (left and above): 1 or 4.
Extended block size:
   Spatial GPM is extended to be further applied to 4×8, 8×4, 4×16 and 16×4 blocks, which can be described as 4<=width<=64, 4<=height<=64, width<height*8, height<width*8, width*height>=32.
Adaptive blending:
   Adaptive blending is tested for spatial GPM, where blending depth τ is derived as follows:
      If min (width, height)==4, ½ τ is selected,
      else if min (width, height)==8, τ is selected,
      else if min (width, height)==16, 2 τ is selected,
      else if min (width, height)==32, 4 τ is selected,
      else, 8 τ is selected.
         2.1.2. Inter prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction,
Merge mode with MVD (MMVD),
Symmetric MVD (SMVD) signalling,
Affine motion compensated prediction,
Subblock-based temporal motion vector prediction (SbTMVP),
Adaptive motion vector resolution (AMVR),
Motion field storage: 1/16th luma sample MV storage and 8×8 motion field compression,
Bi-prediction with CU-level weight (BCW),
Bi-directional optical flow (BDOF),
Decoder side motion vector refinement (DMVR),
Geometric partitioning mode (GPM),
Combined inter and intra prediction (CIIP).

The following text provides the details on those inter prediction methods specified in VVC.

### 2.1.2.1. Extended Merge Prediction

In VVC, the merge candidate list is constructed by including the following five types of candidates in order:
1) Spatial MVP from spatial neighbour CUs,
2) Temporal MVP from collocated CUs,
3) History-based MVP from an FIFO table,
4) Pairwise average MVP,
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.2.1.1. Spatial Candidates Derivation

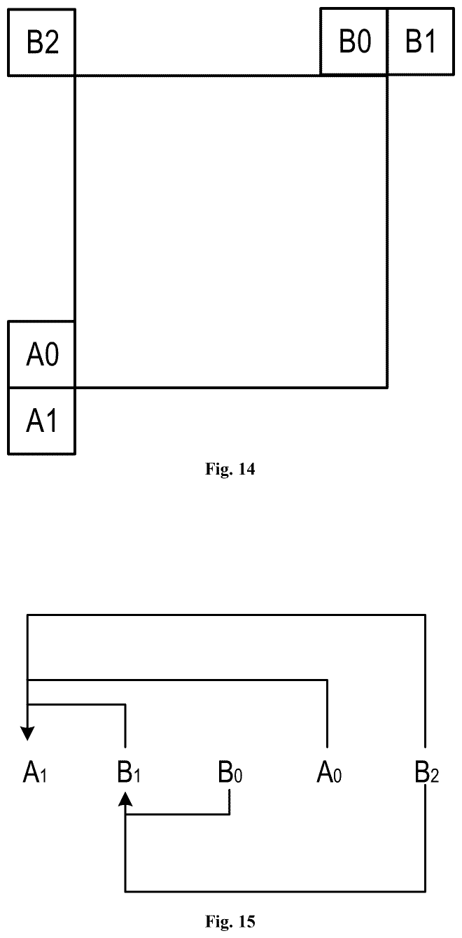

The derivation of spatial merge candidates in VVC is same to that in HEVC except the positions of first two merge candidates are swapped. A maximum of four merge candidates are selected among candidates located in the positions depicted in FIG. 14. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 15 are considered and a candidate is only added to the list if the corresponding candidate used for redundancy check has not the same motion information.

### 2.1.2.1.2. Temporal Candidates Derivation

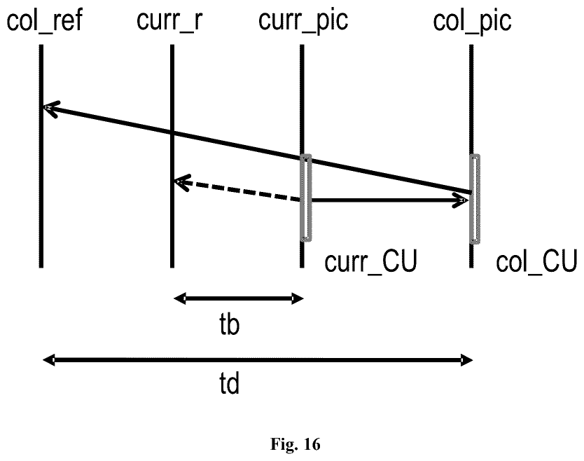

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 16, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

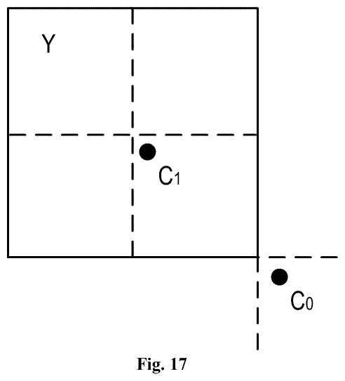

The position for the temporal candidate is selected between candidates C₀ and C₁, as depicted in FIG. 17. If CU at position C₀ is not available, is intra coded, or is outside of the current row of CTUs, position C₁ is used. Otherwise, position C₀ is used in the derivation of the temporal merge candidate.

### 2.1.2.1.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate. The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4)?M:(8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.2.1.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.1.2.2. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.2.3. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

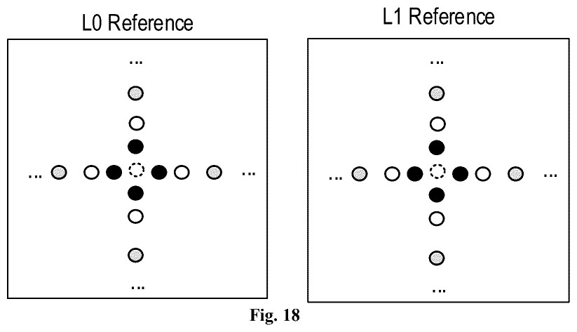

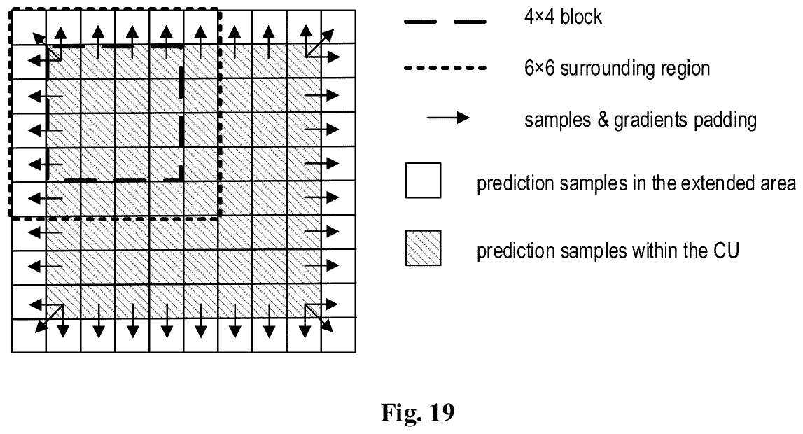

Distance index specifies motion magnitude information and indicate the pre-defined offset from the starting point. As shown in FIG. 18, an offset is added to either horizontal component or vertical component of starting MV. The relation of distance index and pre-defined offset is specified in Table 2-5.

TABLE 2-5
The relation of distance index and pre-defined offset

| Distance IDX | 0 | 1 | 2 | 3 | 4 | 5 | 6 | 7 |
|---|---|---|---|---|---|---|---|---|
| Offset (in unit | ¼ | ½ | 1 | 2 | 4 | 8 | 16 | 32 |
| of luma sample) | | | | | | | | |

Direction index represents the direction of the MVD relative to the starting point. The direction index can represent of the four directions as shown in Table 2-6. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-6 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2-6 specifies the sign of MV offset added to the list0 MV component of starting MV and the sign for the list1 MV has opposite value.

TABLE 2-6
Sign of MV offset specified by direction index

Direction IDX

| | 00 | 01 | 10 | 11 |
|---|---|---|---|---|
| x-axis | + | − | N/A | N/A |
| y-axis | N/A | N/A | + | − |

2.1.2.4. Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3 \qquad ( 2 - 7 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w={3,4,5}) are used.
At the encoder, fast search algorithms are applied to find the weight index without significantly increasing the encoder complexity. These algorithms are summarized as follows. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### 2.1.2.5. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier. BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the ATMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\begin{matrix}\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )\end{matrix} \qquad ( 2 - 8 )$$

where I^{(k)}(i, j) are the sample value at coordinate (i, j) of the prediction signal in list k, k=0,1, and shift1 is calculated based on the luma bit depth, bitDepth, as shift1=max (6, bitDepth−6).

Then, the auto- and cross-correlation of the gradients, S₁, S₂, S₃, S₅ and S₆, are calculated as:

$${S}_{1} = {\sum }_{( i , j ) ∈ Ω} Abs ( {ψ}_{χ} ( i , j ) ) , {S}_{3} = {\sum }_{( i , j ) ∈ Ω} θ ( i , j ) \cdot Sign ( {ψ}_{x} ( i , j ) ) \qquad ( 2 - 9 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$$\begin{matrix}{ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \\ θ ( i , j ) = ( {I}^{( 1 )} ( i , j ) ≫ {n}_{b} ) - ( {I}^{( 0 )} ( i , j ) ≫ {n}_{b} )\end{matrix} \qquad ( 2 - 10 )$$

where Ω is a 6×6 window around the 4×4 subblock, and the values of nₐ and nₚ are set equal to min(1, bitDepth−11) and min(4, bitDepth−8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \qquad ( 2 - 11 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 )$$

$$≫ ⌊ {log}_{2} {S}_{5} ⌋ ) ) : 0$$

where S_{2,m}=S₂>>nₛ_{₂}, S_{2,s}=S₂&(2^{ns}^{₂}−1), th′_{BIO}=2^{max(5,BD-7)}. └·┘ is the floor function, and nₛ_{₂}=12. Based on the motion refinement and the gradients, the following adjustment is calculated for each sample in the 4×4 subblock:

$$b ( x , y ) = rnd ( \text{} ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 12 )$$

Finally, the BDOF samples of the CU are calculated by adjusting the bi-prediction samples as follows:

$$p r e {d}_{B D O F} ( x , y ) = ( {I}^{( 0 )} ( x , y ) + {I}^{( 1 )} ( x , y ) + b ( x , y ) + {0}_{offset} ) ≫ shift \qquad ( 2 - 13 )$$

These values are selected such that the multipliers in the BDOF process do not exceed 15-bit, and the maximum bit-width of the intermediate parameters in the BDOF process is kept within 32-bit.

In order to derive the gradient values, some prediction samples I^{(k)} (i, j) in list k (k=0,1) outside of the current CU boundaries need to be generated. As depicted in FIG. 19, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.2.6. Symmetric MVD Coding

In VVC, besides the normal unidirectional prediction and bi-directional prediction mode MVD signalling, symmetric MVD mode for bi-predicational MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 14 )$$

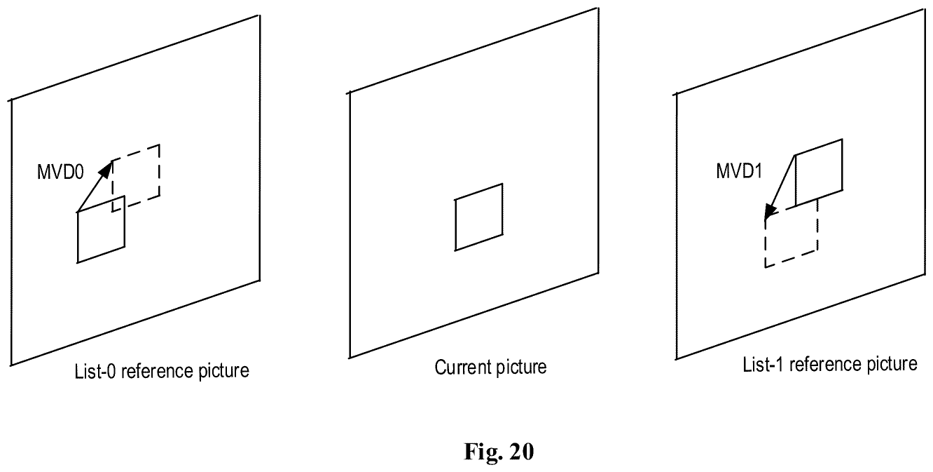

FIG. 20 illustrates a schematic diagram of an illustration for symmetrical MVD mode. In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.1.2.7. Decoder Side Motion Vector Refinement (DMVR)

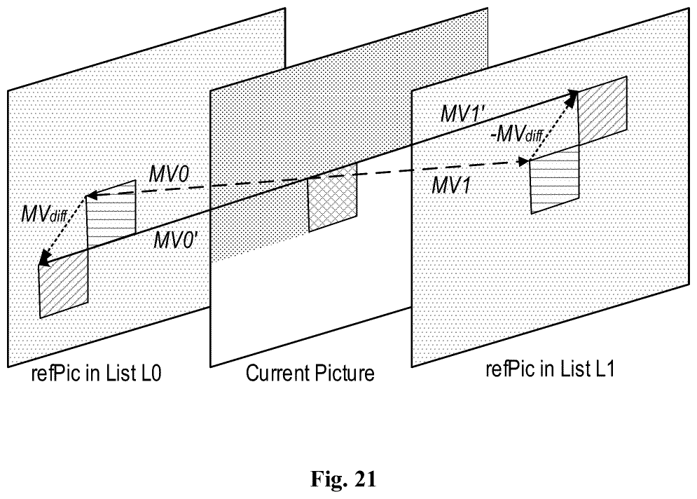

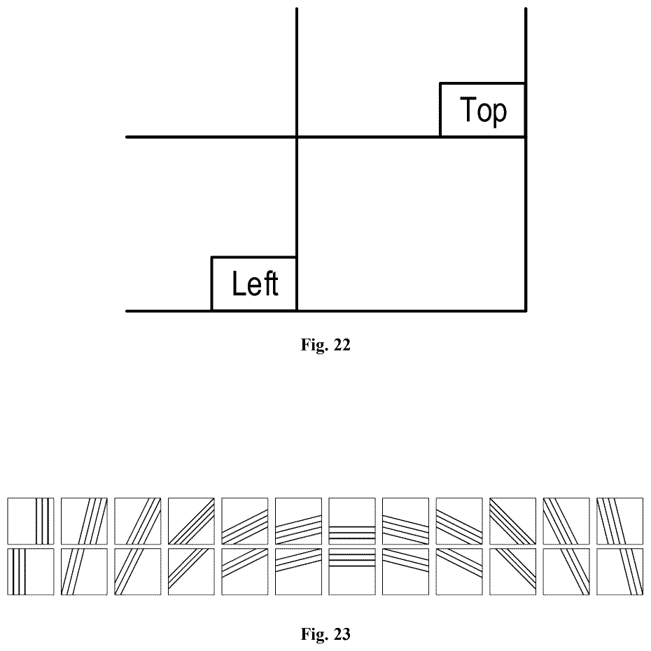

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 21 illustrates a decoding side motion vector refinement. As illustrated in FIG. 21, the SAD between the red blocks based on each MV candidate around the initial MV is calculated. The MV candidate with the lowest SAD becomes the refined MV and used to generate the bi-predicted signal.

In VVC, the DMVR can be applied for the CUs which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.2.7.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 2 - 15 )$$

$$MV {1}^{′} = MV 1 - MV\_offset \qquad ( 2 - 16 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 2 - 17 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 - 18 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 2 - 19 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.2.7.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.2.7.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.2.8. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{i n t e r} + w t * {P}_{i n t r a} + 2 ) ≫ 2 \qquad ( 2 - 20 )$$

### 2.1.2.9. Multi-Hypothesis Prediction (MHP)

Up to two additional predictors are signalled on top of inter AMVP mode, regular merge mode, and MMVD mode. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

### 2.1.2.10. Overlap Subblock Based Motion Compensation (OBMC)

When OBMC is applied, top and left boundary pixels of a CU are refined using neighboring block's motion information with a weighted prediction.

Conditions of not applying OBMC are as follows:
When OBMC is disabled at SPS level,
When current block has intra mode or IBC mode,
When current block applies LIC,
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

### 2.1.2.11. Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, a*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 2.1.2.12. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line, as shown in FIG. 23. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### 2.1.2.12.1. Uni-Prediction Candidate List Construction

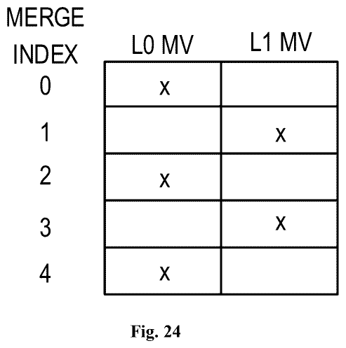

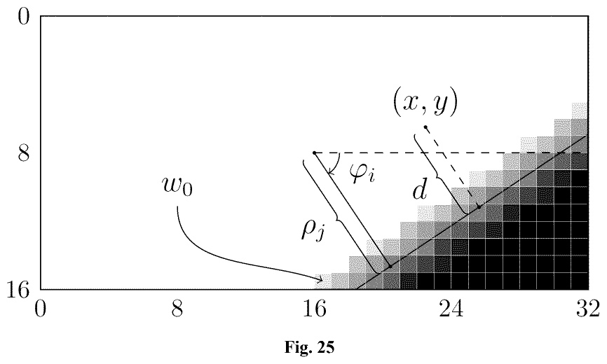

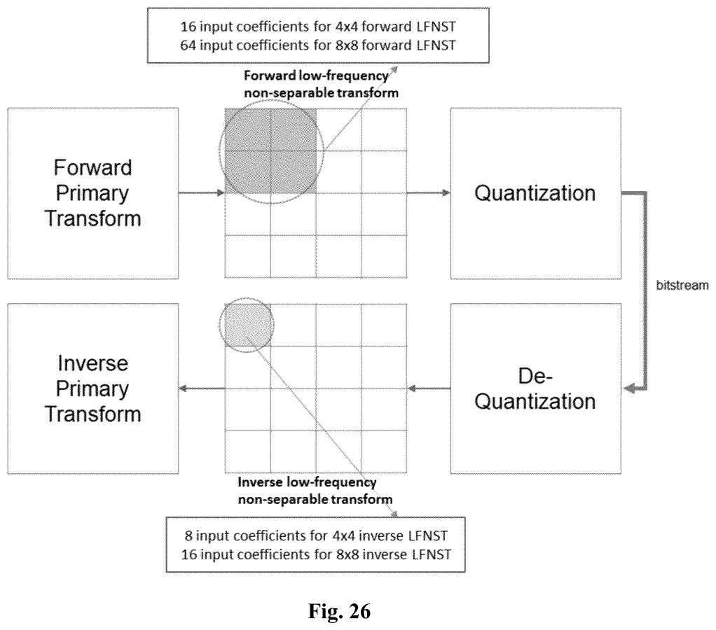

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 24. In case a corresponding LX motion vector of the n-the extended merge candidate does not exist, the L(1−X) motion vector of the same candidate is used instead as the uni-prediction motion vector for geometric partitioning mode.

### 2.1.2.12.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 21 )$$

$${ρ}_{j} = {ρ}_{x , j} cos ( {φ}_{i} ) + {ρ}_{y , j} sin ( {φ}_{i} ) \qquad ( 2 - 22 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 23 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 24 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 25 )$$

$${w}_{0} ( x , y ) = \frac{C l i p 3 ( 0 , 8 , ( wIdxL ( x , y ) + 4 ) ≫ 3 )}{8} \qquad ( 2 - 26 )$$

$${w}_{1} ( x , y ) = 1 - {w}_{0} ( x , y ) \qquad ( 2 - 27 )$$

The partIdx depends on the angle index i. One example of weigh w₀ is illustrated below.

### 2.1.2.12.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU. The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 28 )$$

where motionIdx is equal to d(4x+2,4y+2). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:

1) If Mv1 and Mv2 are from different reference picture lists (one from L0 and the other from L1), then Mv1 and Mv2 are simply combined to form the bi-prediction motion vectors.

2) Otherwise, if Mv1 and Mv2 are from the same list, only uni-prediction motion Mv2 is stored.

2.1.2.12.4. GPM with Inter and Intra Prediction (GPM Inter-Intra)

With the GPM inter-intra, pre-defined intra prediction modes against geometric partitioning line can be selected in addition to merge candidates for each non-rectangular split region in the GPM-applied CU. In the proposed method, whether intra or inter prediction mode is determined for each GPM-separated region with a flag from the encoder. When the inter prediction mode, a uni-prediction signal is generated by MVs from the merge candidate list. On the other hand, when the intra prediction mode, a uni-prediction signal is generated from the neighboring pixels for the intra prediction mode specified by an index from the encoder. The variation of the possible intra prediction modes is restricted by the geometric shapes. Finally, the two uni-prediction signals are blended with the same way of ordinary GPM.

### 2.1.3. Transform and Quantization

2.1.3.1. Large Block-Size Transforms with High-Frequency Zeroing

In VVC, large block-size transforms, up to 64×64 in size, are enabled, which is primarily useful for higher resolution video, e.g., 1080p and 4K sequences. High frequency transform coefficients are zeroed out for the transform blocks with size (width or height, or both width and height) equal to 64, so that only the lower-frequency coefficients are retained. For example, for an M×N transform block, with M as the block width and N as the block height, when M is equal to 64, only the left 32 columns of transform coefficients are kept. Similarly, when N is equal to 64, only the top 32 rows of transform coefficients are kept. When transform skip mode is used for a large block, the entire block is used without zeroing out any values. In addition, transform shift is removed in transform skip mode. The VTM also supports configurable max transform size in SPS, such that encoder has the flexibility to choose up to 32-length or 64-length transform size depending on the need of specific implementation.

### 2.1.3.2. Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 2-7 shows the basis functions of the selected DST/DCT.

TABLE 2-7
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 2-8. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 2-8
Transform and signalling mapping table

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.1.3.3. Low-Frequency Non-Separable Transform (LFNST)

In VVC, LFNST is applied between forward primary transform and quantization (at encoder) and between de-quantization and inverse primary transform (at decoder side). In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 2 - 29 )$$

is first represented as a vector [symbol] :

$$\vec{X} = {[ {X}_{00} {X}_{01} {X}_{02} {X}_{03} {X}_{10} {X}_{11} {X}_{12} {X}_{13} {X}_{20} {X}_{21} {X}_{22} {X}_{23} {X}_{30} {X}_{31} {X}_{32} {X}_{33} ]}^{T} \qquad ( 2 - 30 )$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### 2.1.3.3.1. Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & … & {t}_{R N}\end{matrix} ] \qquad ( 2 - 31 )$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### 2.1.3.3.2. LFNST Transform Selection

There are totally 4 transform sets and 2 non-separable transform matrices (kernels) per transform set are used in LFNST. The mapping from the intra prediction mode to the transform set is pre-defined as shown in Table 2-9. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 2-9
Transform selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

2.1.3.3.3. LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### 2.1.3.4. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

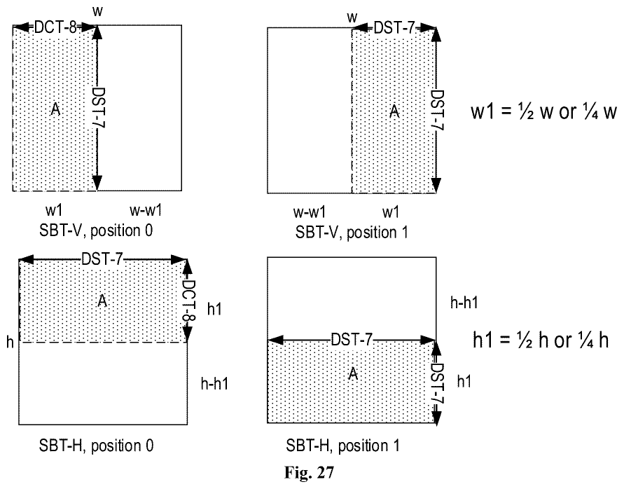

When SBT is used for an inter-coded CU, SBT type and SBT position information are signaled in the bitstream. There are two SBT types and two SBT positions, as indicated in FIG. 27. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 27. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 2.1.3.5. Maximum Transform Size and Zeroing-Out of Transform Coefficients

Both CTU size and maximum transform size (i.e., all MTS transform kernels) are extended to 256, where the maximum intra coded block can have a size of 128×128. The maximum CTU size is set to 256 for UHD sequences and it is set to 128, otherwise. In the primary transformation process, there is no normative zeroing out operation applied on transform coefficients. However, if LFNST is applied, the primary transform coefficients outside the LFNST region are normatively zeroed-out.

### 2.1.3.6. Enhanced MTS for Intra Coding

In an existing design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 4 different transform pairs are considered, the same as that of VVC. Note, although a total of 80 different classes are considered, some of those different classes often share exactly same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

MTS index [0,3] is signalled with 2 bit fixed-length coding.

2.1.3.7. Secondary Transformation: LFNST Extension with Large Kernel

The LFNST design in VVC is extended as follows:
The number of LFNST sets(S) and candidates (C) are extended to S=35 and C=3, and the LFNST set (IfnstTrSetIdx) for a given intra mode (predModeIntra) is derived according to the following formula:

$$For predModeIntra < 2 , lfnstTrSetIdx is equal to 2 , lfnstTrSetIdx = predModeIntra , for predModeIntra in [ 0 , 34 ] , lfnstTrSetIdx = 68 - predModeIntra , for predModeIntra in [ 35 , 66 ] .$$

Three different kernels, LFNST4, LFNST8, and LFNST16, are defined to indicate LFNST kernel sets, which are applied to 4×N/N×4 (N>4), 8×N/N×8 (N≥8), and M×N (M, N≥16), respectively.

The kernel dimensions are specified by:

$$( LFSNT 4 , LFNST {8}^{*} , and LFNST {16}^{*} ) = ( 16 \times 16 , 32 \times 64 , 32 \times 96 )$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

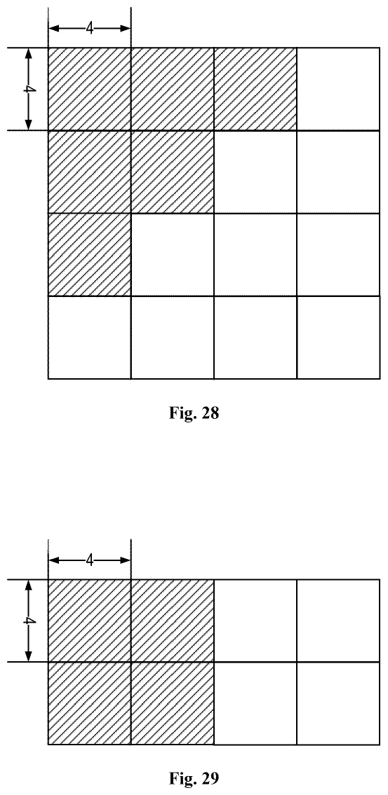

The ROI for LFNST16 is depicted in FIG. 28. It consists of six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order.

The ROI for LFNST8 is shown in FIG. 29. The forward LFNST8 matrix can be R×64 and R is chosen to be 32.

The generated coefficients are located in the same manner as with LFNST16.

The mapping from intra prediction modes to these sets is shown in Table 2-10.

TABLE 2-10
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |

| Intra pred. mode | 18 | 19 | 20 | 21 | 22 | 23 | 24 | 25 | 26 | 27 | 28 | 29 | 30 | 31 | 32 | 33 |
|---|---|---|---|---|---|---|---|---|---|---|---|---|---|---|---|---|
| LFNST set index | 18 | 19 | 20 | 21 | 22 | 23 | 24 | 25 | 26 | 27 | 28 | 29 | 30 | 31 | 32 | 33 |

| Intra pred. mode | 34 | 35 | 36 | 37 | 38 | 39 | 40 | 41 | 42 | 43 | 44 | 45 | 46 | 47 | 48 | 49 |
|---|---|---|---|---|---|---|---|---|---|---|---|---|---|---|---|---|
| LFNST set index | 34 | 33 | 32 | 31 | 30 | 29 | 28 | 27 | 26 | 25 | 24 | 23 | 22 | 21 | 20 | 19 |

| Intra pred. mode | 50 | 51 | 52 | 53 | 54 | 55 | 56 | 57 | 58 | 59 | 60 | 61 | 62 | 63 | 64 | 65 |
|---|---|---|---|---|---|---|---|---|---|---|---|---|---|---|---|---|
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

### 2.1.3.8. Non-Separable Primary Transform for Intra Coding (NSPT)

DCT-II+LFNST is replaced by NSPT for the block sizes 4×4, 4×8, 8×4 and 8×8. The NSPTs follows the design of LFNST, i.e. 3 candidates and 35 sets, chosen based on the intra mode. The kernel sizes are as follows:
NSPT4×4: 16×16,
NSPT4×8/NSPT8×4: 32×20,
NSPT8×8: 64×32.

Therefore, 12 and 32 coefficients are zeroed-out for NSPT4×8/NSPT8×4 and NSPT8×8 respectively.

### 2.1.3.9. Sign Prediction

The basic idea of the coefficient sign prediction method is to calculate reconstructed residual for both negative and positive sign combinations for applicable transform coefficients and select the hypothesis that minimizes a cost function.

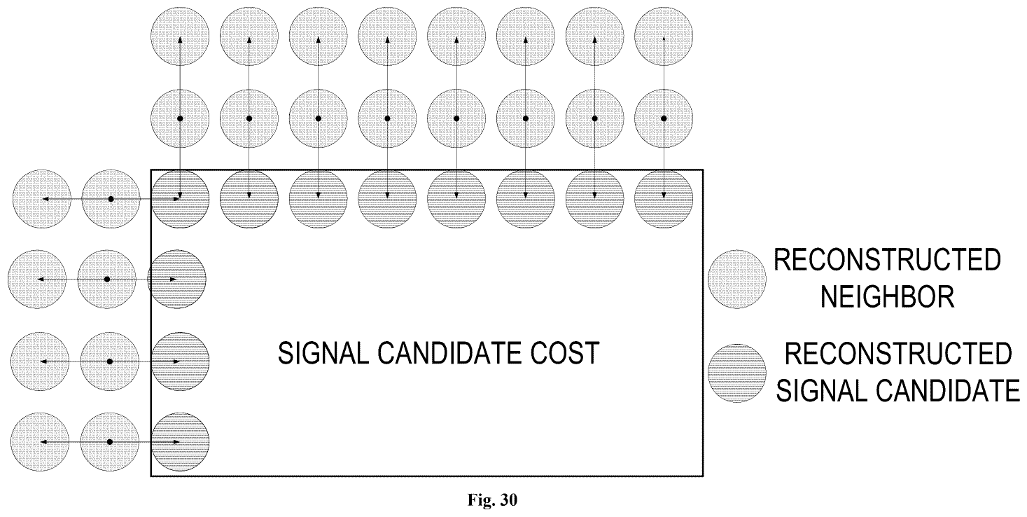

To derive the best sign, the cost function is defined as discontinuity measure across block boundary shown on FIG. 30. It is measured for all hypotheses, and the one with the smallest cost is selected as a predictor for coefficient signs.

The cost function is defined as a sum of absolute second derivatives in the residual domain for the above row and left column as follows:

$$cost = {\sum }_{x = 0}^{w} \vert ( - {R}_{x , - 1} + 2 {R}_{x , 0} - {P}_{x , 1} ) - {r}_{x , 1} \vert + {\sum }_{y = 0}^{h} \vert ( - {R}_{- 1 , y} + 2 {R}_{0 , y} - {P}_{1 , y} ) - {r}_{1 , y} \vert$$

where R is reconstructed neighbors, P is prediction of the current block, and r is the residual hypothesis. The term (−R₋₁+2R₀−P₁) can be calculated only once per block and only residual hypothesis is subtracted.

### 3. Problems

There are several issues in the existing video coding techniques, which would be further improved for higher coding gain.
1. In ECM-7.0 SGPM mode, same blending width determination mechanism is used for natural camera captured content and screen content, which is not optimal. Generally, screen content videos are more likely having sharp edges, which may prefer narrower blending width or no blending.
2. The coding mode storage for SGPM mode could be further specified.
3. In ECM-7.0, same candidates are used as possible blending width for both GPM mode and SGPM mode, which may be further improved.
4. How to apply transform for a SGPM coded block may be further specified.

### 4. Detailed Solutions

The detailed solutions below should be considered as examples to explain general concepts. These solutions should not be interpreted in a narrow way. Furthermore, these solutions can be combined in any manner.

The term ‘GPM’ may represent a coding method that splits one block into two or more sub-regions/partitions wherein at least one sub-region/partition couldn't be generated by any of existing partitioning structure (e.g., QT/BT/TT). The term ‘GPM’ may indicate the triangle prediction mode (TPM), and/or geometric merge mode (GEO), and/or wedge prediction mode, and/or geometric partitioning mode (GPM), and/or GPM MMVD mode, and/or GPM template matching mode, and/or GPM inter-inter mode, and/or GPM inter-intra mode, and/or GPM intra-intra mode, and/or spatial GPM (SGPM) mode.

The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

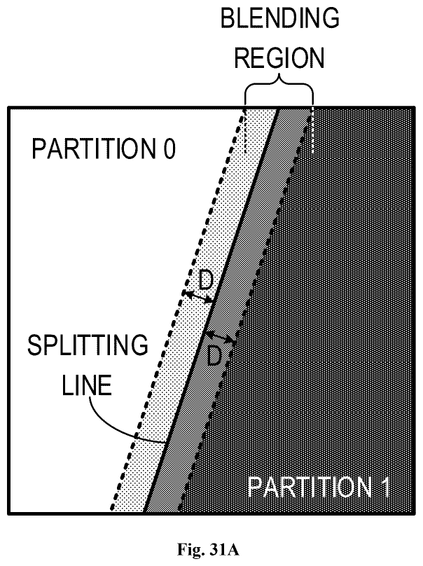

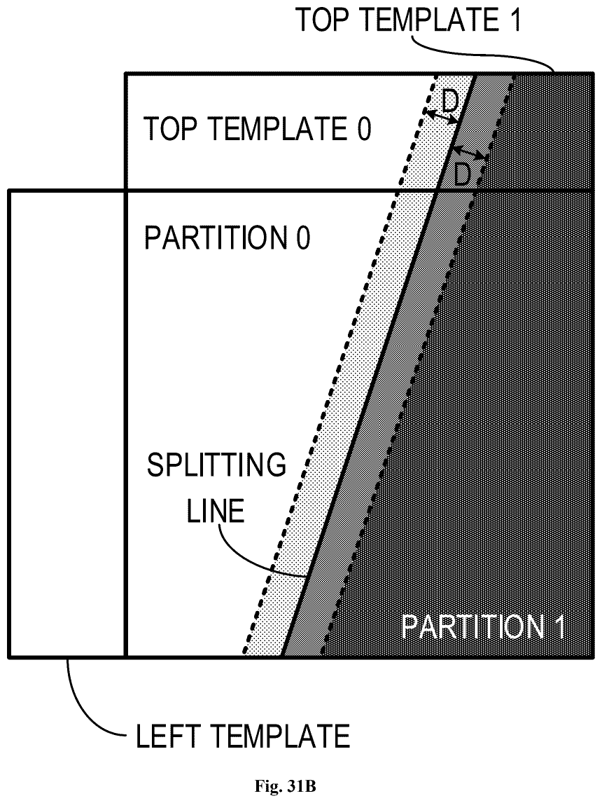

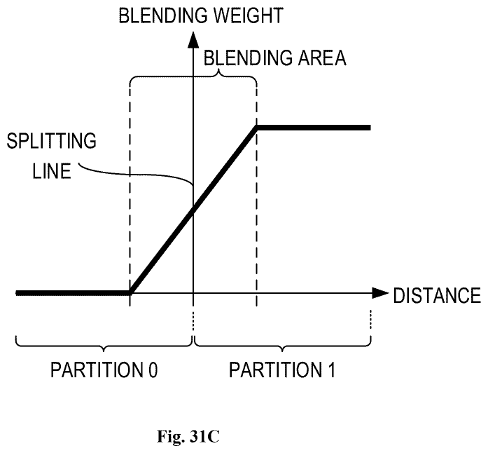

It is noted that the terminologies mentioned below are not limited to the specific ones defined in existing standards. Any variance of the coding tool is also applicable. FIG. 31A illustrates an example of blending partition 0 and partition 1 of a geometric partitioning block, and FIG. 31B illustrates an example of blending top template 0 and top template 1, wherein “D” denotes the blending width. FIG. 31C illustrates examples of the blending area width D and a ramp function for the weights derivation based on the distance from a predicted sample position to the splitting line. A sample within the blending area needs to be blended with another sample in the other partition in order to generate a final prediction sample, while a sample outside the blending area is directly used as a final prediction sample without blending.
4.1. On the 1st issue about the blending method of geometric partitioning and related issues, the following methods are proposed (for example, as shown in FIGS. 31A and 31B, assume the current block is divided into two partitions through a geometric splitting line, for samples around the splitting line, a weighted blending process is conducted to fuse each of two samples from partition0 and partition1 and output one blended sample value. Note that the blending method may or may not be applied to the template of the current block):
1. Different blending rules/methods may be allowed for a video unit, in which at least one sample within the video unit may be generated by blending/fusing more than one sample from more than one geometric partition of the video unit, wherein the video unit is coded with a certain mode.
   a. The video unit may refer to a video block.
      i. Furthermore, the coding unit may refer to a template of the video block, wherein the template may be constructed from (top and/or left) samples neighboring to the video block.
         1. For example, the partitioning method of the video block may be extended to the template, resulting in more than one group of samples within the template (as an example in FIG. 31B, wherein the coding information (such as mode, motion, etc.) of top template 0 and top template 1 may be different).
         2. For example, the blending method in this disclosure may be applied to the template.
   b. The allowed blending methods may refer to at least one of the followings:
      i. For example, blending width is adaptively determined based on coding information, such as block dimension (e.g., width and/or height).
         1. For example, multiple candidates are pre-defined in the codec, and which one is used to the video unit is determined by width and/or height of the block.
      ii. For example, blending width is indicated based on a signalled syntax element.
         1. For example, multiple candidates are pre-defined in the codec, and which one is used to the video unit is determined at the encoder and signalled to the decoder.
         2. For example, specifically, the available width candidates and/or the maximum number of allowed blending width for a video unit may be dependent on coding information or content type.
         a. For example, the coding information may refer to split/partition mode/method.
         b. For example, the coding information may refer to block dimensions (e.g., width and/or height).
         c. For example, the content type indicates whether the video unit belongs to screen content.
         d. For example, the content type indicates whether the video unit belong to natural (e.g., camera captured) content.
         e. For example, the content type may be determined by an encoder only method.
         f. For example, the content type may be determined by a decoder derived method (e.g., based on content analyzing method, sample gradients, and etc.).
      iii. For example, blending width is equal to a fixed value.
         1. For example, a fixed blending width is used for all appropriate video units (e.g., regardless of block dimensions).
      iv. For example, no blending (e.g., without blending) method is used.
         1. For example, the blending width is equal to 0.
         2. For example, each output sample within the blending region is from either partition 0 or partition 1 (but not both), depending on the sample location and the position of the splitting line.
         3. For example, don't use blending/fusion process to blend two samples into one sample.
      v. For example, only partial samples within the blending region need to perform blending operation.
         1. For example, whether a sample need to be blended is dependent on the difference between the sample values respectively from partition 0 and 1.
   c. Which blending method (e.g., more than one blending method is defined in the codec) used to the video unit may be determined based on syntax element(s) (SE).
      i. For example, at least one syntax element is signalled in the bitstream.
      ii. For example, which blending method is used may be controlled based on high level syntax elements (e.g., a flag, and/or an index) signalled at SPS/VPS/PPS/group of pictures/picture header/picture/subpicture/slice header/slice/group of tiles/tile/brick level.
      iii. For example, which blending method is used may be controlled based on block level syntax elements (e.g., a flag, and/or an index) signalled at block/CTU/CU/TU/PU/VPDU level.
      iv. For example, a first blending method may be used when the syntax flag is equal to a first value (e.g., 1 or 0), whereas a second blending method may be used when the syntax flag is equal to a second value (e.g., 0 or 1).
      V. The SE may be predictively coded.
      vi. The SE may be coded with at least one context.
      vii. For example, the video unit may be a sequence, or a group of pictures, or a picture, or a slice, or a tile, or a subpicture.
   d. For example, more than one blending method may be allowed for X-coded blocks in a video unit.
      i. For example, the video unit may be a sequence, or a group of pictures, or a picture, or a slice.
      ii. For example, whether the first blending method or the second blending method is used for the video unit, may be determined by a syntax element signalled at SPS, or PPS, or picture header, or slice header level.
      iii. For example, when a blending method is used for a video unit, such blending method is applied for all blocks (in the video unit) coded with a certain mode X.
      iv. For example, X may be SGPM, and/or GPM, and/or GPM inter-intra, and/or GPM-TM and/or GPM-MMVD, and/or its variants.
      v. For example, X may be PredA-PredB-GPM (e.g., a prediction mode in which a block is geometrically split into two partitions, one is coded with PredA and the other is coded with PredB), and/or its variants.
         1. For example, predA may be a certain Inter mode, while predB may be a certain Intra mode.
         2. For example, predA may be a certain Inter mode, while predB may be another type of Inter mode.
         3. For example, predA may be a certain Intra luma mode, while predB may be another type of Intra luma mode.
         4. For example, predA may be a certain Intra chroma mode, while predB may be another type of Intra chroma mode.
         5. For example, predA may be IBC (or its variant), while predB may be an Intra mode.
         6. For example, predA may be IBC (or its variant), while predB may be an Inter mode.
         7. For example, predA may be IntraTMP, while predB may be an Inter mode.
      vi. For example, X may be CIIP, and/or CIIP-TM, and/or CIIP-MMVD, and/or its variants.
      vii. For example, a first blending method may refer to a fixed blending area width (e.g., regardless of the block width and block height).
         1. For example, the blending area width is equal to a fixed number (such as a half sample, ½ sample), as depicted in FIG. 31C.
         2. For example, assume the blending area width is equal to a half sample (½ sample).
         a. For example, in case that a splitting line separates a block into two partitions vertically or horizontally (e.g., angle index equal to 0/8/16/24, or angle equal to 0/80/180/270 degree), no blending is applied for samples in partition −0 and partition −1.
         i. In such case, the distance from any sample in a partition to the splitting line is no less than ½ sample.
         b. For example, in case that a splitting line is an angular oblique line (e.g., angle index not equal to 0/8/16/24, or angle not equal to 0/80/180/270 degree), whether and how to blend may be decided by the distance from a prediction sample and the splitting line (i.e., blending may be used if the distance from a sample to the splitting line is less than ½ sample).
      viii. For example, a second blending method may refer to an adaptive blending area width determined based on coding information.
         1. For example, different blending area widths may be used for different blocks coded with a certain mode (e.g., SGPM, and/or GPM, and/or its variants).
         a. For example, the blending area width for a certain block is adaptively determined based on coding information.
         2. For example, a blending area width may be determined based on a block size (width and/or height).
         a. For example, a larger blending area width may be used for large blocks, while a smaller blending area width may be used for small blocks.
         b. For example, an adaptive blending area width may be derived for a block, according to the following rule (e.g., T1=4, T2=8, T3=16, T4=32, D1=1, D2=2, D3=4, D4=8, D5=16):
         If min(W,H)=T1, blending area width equal to D1 samples is used;
         else if min(W,H)=T2, blending area width equal to D2 samples is used;
         else if min(W,H)=T3, blending area width equal to D3 samples is used;
         else if min(W,H)=T4, blending area width equal to D4 samples is used;
         else, blending area width equal to D5 samples is used.
         3. Alternatively, a blending area width may be determine based on a block level syntax element.
         a. For example, based on a block level signaled/coded blending area width index, a corresponding blending area width is derived for a certain block.
         4. Alternatively, a blending area width may be determined based on a decoder side method (e.g., template-cost-based decoder determination).
         a. For example, based on template costs, one out of M blending area widths may be determined for a certain block, wherein the M blending area widths may refer to more than one pre-defined blending area widths.
         5. For example, for a certain block, a certain blending area width is determined for the video block, and a blending weight is calculated for a prediction sample, according to the distance from the predicted sample to the splitting line.
      ix. Alternatively, a second blending method may refer to a different blending weight derivation method (e.g., different from the blending weight derivation method used in the first blending method).
         1. For example, a first blending method is based on fixed/predefined weights, while the second blending method is based on derived/adaptive weights (e.g., coding information dependent).
   e. Which blending method (e.g., more than one blending method may be defined in the codec) used to the video unit may be determined based on an implicit rule.
      i. For example, no syntax element in used to make the decision.
         1. For example, it may be determined by a decoder derived method (e.g., based on content analyzing method, sample gradients, and etc.).
      ii. For example, an encoder only method is used to determine which blending method is used.
      iii. For example, the blending method may be based on the content type of a video unit.
         1. For example, whether the video unit belongs to screen content.
         2. For example, whether the video unit belong to natural (e.g., camera captured) content.
         3. For example, the content type may be determined by an encoder only method.
         4. For example, the content type may be determined by a decoder derived method (e.g., based on content analyzing method, sample gradients, and etc.).
   f. The video unit may be coded with at least one of the following techniques:
      i. A compound prediction in which at least one sample of the video unit may be fused/blended from more than one samples,
      ii. SGPM (e.g., GPM intra-intra),
      iii. GPM (e.g., GPM inter-inter),
      iv. GEO,
      V. GPM inter-intra,
      vi. GPM TM,
      vii. GPM MMVD,
      viii. TPM,
      ix. Wedge prediction,
      X. MHP and/or its variants,
      xi. CIIP and/or its variants,
      xii. OBMC and/or its variants,
      xiii. TIMD and/or its variants,
      xiv. DIMD and/or its variants,
      XV. Intra luma fusion,
      xvi. Intra chroma fusion.
   g. For example, a SE (such as a flag) may be signalled at a syntax structure level (e.g., SPS level, or PPS level), indicating whether to and/or how to generate samples around the splitting line of a GPM (e.g., SGPM) coded block are with blending.
      i. For example, for a certain video type (such as SCC videos), the blending method may be disabled.
      ii. For example, in such case, each output sample within the blending region is from either partition 0 or partition 1 (but not both), depending on the sample location and the position of the splitting line.
   h. For example, a SE (such as a flag) may be signalled at a syntax structure level (e.g., SPS level, or PPS level), indicating samples around the splitting line of a GPM (e.g., SGPM) coded block are generated by a fixed blending width (e.g., X sample in each partition, for example, X=1 or 2).
   i. For example, for a certain video type (such as SCC videos), the blending width is equal to a fixed value (e.g., a narrow blending width).
2. Whether to and/or how to perform a blending method of geometric partitioning may depend on color format/color components.
   a. In one example, SGPM may be applied to a chroma component such as Cb or Cr.
      i. In one example, the blending method of SGPM may be different on luma and chroma.
      ii. In one example, the blending method of SGPM may be the same on luma and chroma.
   b. In one example, how to apply SGPM on a block of a chroma component may depend on information of collocated luma component.
4.2. On the 2^{nd} issue about coding information storage of geometric partitioning coded block and related issues, the following methods are proposed:
1. Assume a geometric partitioning mode (e.g., SGPM) coded video unit contains two intra partitions, how to store the intra prediction modes or which intra mode is used for succeeding process may be dependent on coding information.
   a. For example, the coding information may refer to split/partition mode/method.
   b. For example, the coding information may refer to block dimensions (e.g., width and/or height).
   c. For example, subblock based mode information may be stored for the video unit.
      i. For example, each 4×4 block may store an intra mode.
      ii. For example, each 8×8 block may store an intra mode.
      iii. For example, for a subblock outside the blending region but inside the video unit (e.g., an example is shown in FIGS. 31A and 31B), the intra mode of the corresponding partition may be stored.
      iv. For example, for a subblock within the blending region (e.g., an example is shown in FIGS. 31A and 31B), either intra mode of partition 0 or intra mode of partition 1 may be stored (but not both).
         1. For example, whether to store the intra mode of partition 0 or 1 may be dependent on the distance between the subblock location (e.g., center, or top-left, or top-right, etc.) and the position of the splitting/partitioning line.
         2. For example, whether to store the intra mode of partition 0 or 1 may be dependent on a decoder derived method.
         3. For example, the intra mode of partition X (X=1, or 0) may be stored always for subblocks within the blending region.
   d. For example, block-based mode information may be stored for the video unit.
      i. For example, each CU/PU may store an intra mode.
      ii. For example, the intra mode of partition X (X=1, or 0) may be stored always for the current CU/PU.
      iii. For example, the intra mode of a specified subblock may be stored for the current CU/PU.
         1. For example, the specified subblock may refer to the subblock at a specified position (e.g., center, or top-left, or top-right, or bottom-right, or bottom-left, and etc.) of the current CU/PU.
   e. For example, partition-based mode information may be stored for the video unit.
      i. For example, each partition may store an intra mode (e.g., two intra modes are stored for a SGPM coded block).
   f. For example, a decoder derived intra mode may be stored for the current CU/PU/partition/subblock.
      i. For example, the decoder derived intra mode may be generated based on samples in the corresponding template.
         1. For example, based on gradient of the (reconstructed) samples in the template.
      ii. For example, the decoder derived intra mode may be generated based on the final blended prediction samples of the current CU/PU.
         1. For example, based on gradient of the final blended prediction samples.
      iii. For example, the decoder derived intra mode may be generated based on TIMD and/or its variants.
      iv. For example, the decoder derived intra mode may be generated based on DIMD and/or its variants.
   g. For example, the stored intra mode information may be used for the following succeeding process:
      i. For example, for current block's primary transform (e.g., mode-depended transform core selection).
      ii. For example, for current block's secondary transform (e.g., mode-depended transform core selection).
      iii. For example, for current block's in-loop filter process (e.g., deblocking filter decision, and/or deblocking filter strength, etc.).
      iv. For example, for current block's LMCS process.
      V. For example, for history based intra mode derivation.
      vi. For example, for future/succeeding neighbor block's MPM list generation.
      vii. For example, for future/succeeding neighbor block's TIMD temporal mode derivation. For example, for cross-component mode derivation, such as the DM mode.
4.3. On the 3^{rd} issue about blending width for GPM and SGPM and related issues, the following methods are proposed:
1. The blending width candidates allowed for SGPM and GPM (e.g., GPM inter-inter, GPM inter-intra, GPM MMVD, GPM TM, etc.) may be different.
   a. For example, the lengths/values of allowed blending width for SGPM may be different from those of GPM.
   b. For example, the maximum number of allowed blending width for SGPM may be different from that of GPM.
   c. Alternatively, SGPM and GPM (e.g., GPM inter-inter, GPM inter-intra, GPM MMVD, GPM TM, etc.) may share the same blending information.
      i. For example, here the blending information may be the available width candidates and/or the maximum number of allowed blending width.
2. For example, the maximum number of allowed blending width for GPM (and/or SGPM) may be signalled in the bitstream.
   a. For example, high-level syntax element(s) may be signalled at SPS/VPS/PPS/group of pictures/picture header/picture/subpicture/slice header/slice/group of tiles/tile/brick level.
3. For example, the number of allowed blending width for GPM (and/or SGPM) may be derived based on coding information.
   a. For example, in such case, no need to signal the number of allowed blending width for the current video unit.
   b. For example, it may be derived based on the gradient of template and/or prediction of the current video unit.
4. The blending width candidates allowed for SGPM on luma and chroma may be different.
5. For example, the blending area width allowed for SGPM may be a subset of the blending area widths allowed for GPM (and/or its variants such as GPM-TM, GPM-MMVD, GPM inter-intra).
   a. For example, the blending area width allowed for SGPM may be equal to the minimum blending area width allowed for GPM.
   b. For example, whether the blending area width allowed for SGPM is equal to the minimum blending area width of GPM may be signalled in the bitstream.
      i. For example, it may signalled at SPS/VPS/PPS/group of pictures/picture header/picture/subpicture/slice header/slice/group of tiles/tile/brick level.
   c. For example, assume the allowed blending area widths for a GPM coded block are {½, 1, 2, 4, 8} or {½, 1, 2} samples in each side from the splitting line, the blending area width allowed for a SGPM coded block may be equal to ½ sample.
4.4. On the 4^{th} issue about transform of a SGPM coded block and related issues, the following methods are proposed:
1. How to apply primary and/or secondary and/or separable and/or non-separable transform for a SGPM coded video unit may be based on the intra mode and/or partition index of the SGPM coded video unit.
   a. For example, the primary transform may refer to DCT2, MTS, intraMTS, interMTS, KLT, NSPT, KLT, and etc.
   b. For example, the secondary transform may refer to LFNST, NSST, KLT, and etc.
   c. For example, the primary transform may be based on separable transform kernels.
   d. For example, the primary transform may be based on non-separable transform kernels.
   e. For example, the secondary transform may be based on separable transform kernels.
   f. For example, the secondary transform may be based on non-separable transform kernels.
   g. For example, a mode dependent transform kernel selection is applied to the SGPM coded video unit.
   h. For example, a certain transform class (of MTS) may be derived by the intra mode and/or partition index of the SGPM coded video unit.
   i. For example, a certain transform pair (e.g., pair of horizontal transform type and vertical transform type) may be derived by the intra mode and/or partition index of the SGPM coded video unit.
   j. For example, a certain transform type (e.g., KLT, DCT2, DST7, DCT8, DST4, DST1, etc.) may be derived by the intra mode and/or partition index of the SGPM coded video unit.
   k. For example, a transform set (e.g., one out of the 35-transform-set in LFNST/NSPT) may be derived by the intra mode and/or partition index of the SGPM coded video unit.
   l. For example, a transform transpose flag (of LFNST/NSPT) may be derived by the intra mode and/or partition index of the SGPM coded video unit.
   m. For example, it may be determined based on the mode index of the intra mode and/or partition index of the SGPM coded video unit.
      i. For example, a transform class/pair/type/set may be derived based on indexing the intra mode and/or partition index from a look-up-table.
      ii. For example, a transform class/pair/type/set may be derived based on a pre-defined equation using the intra mode index and/or partition index.
   n. For example, it may be determined based on the relationship (e.g., greater, or smaller than) between the intra mode of the SGPM coded video unit and the diagonal intra mode.
2. The primary and/or secondary and/or separable and/or non-separable transform of a SGPM coded video unit may be based on the stored intra mode of such video unit.
   a. For example, the stored intra mode may be derived based on items in the above bullet 4.2.
   b. For example, the stored intra mode at a specified position (e.g., center, or top-left, or top-right, or bottom-right, or bottom-left, and etc.) of current SGPM coded video unit may be used for its primary transform.
   c. For example, the stored intra mode at a specified position (e.g., center, or top-left, or top-right, or bottom-right, or bottom-left, and etc.) of current SGPM coded video unit may be used for its secondary transform.
3. The primary and/or secondary and/or separable and/or non-separable transform of a SGPM coded video unit may be based on a decoder derived intra mode.
   a. For example, the decoder derived intra mode may be generated based on samples in the template of the current video unit.
      i. For example, based on gradient of the (reconstructed) samples in the template, an intra mode may be derived for the current SGPM coded video unit.
   b. For example, the decoder derived intra mode may be generated based on the final blended prediction samples of the current CU/PU.
      i. For example, based on gradient of the final blended prediction samples, a intra mode may be derived for the current SGPM coded video unit.
   c. For example, the decoder derived intra mode may be generated based on TIMD and/or its variants.
   d. For example, the decoder derived intra mode may be generated based on DIMD and/or its variants.
4. The primary and/or secondary and/or separable and/or non-separable transform of a SGPM coded video unit may be just based on the intra mode of a certain partition (such as partition 0 or partition 1).
   a. For example, the intra mode from which partition may be pre-defined.
   b. For example, two intra modes of two partitions may be compared based on a pre-defined rule, and one out the two may be finally selected for transform process.
5. The primary and/or secondary and/or separable and/or non-separable transform of a SGPM coded video unit may be based on a pre-defined intra mode.
   a. For example, the pre-defined mode may be DIMD mode.
   b. For example, the pre-defined mode may be TIMD mode.
   c. For example, the pre-defined mode may be Planar mode.

More details of the embodiments of the present disclosure will be described below which are related to geometric partition. The embodiments of the present disclosure should be considered as examples to explain the general concepts and should not be interpreted in a narrow way. Furthermore, these embodiments can be applied individually or combined in any manner.

As used herein, the term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular.

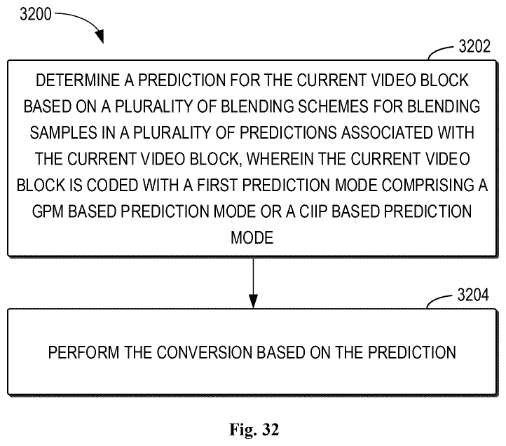

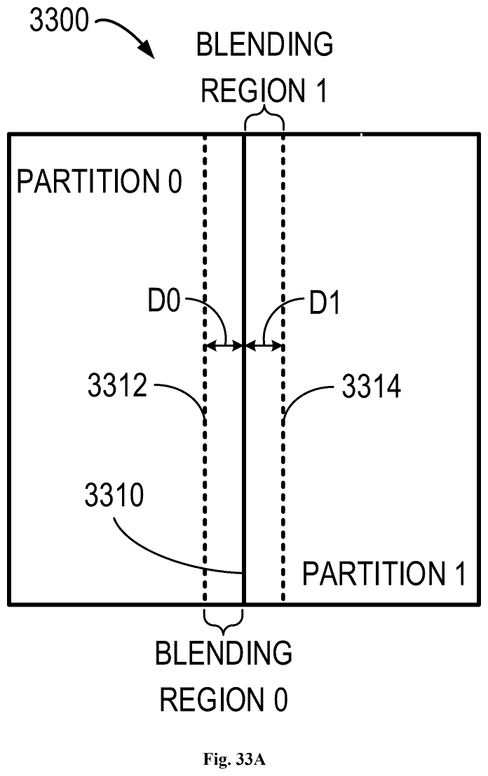

FIG. 32 illustrates a flowchart of a method 3200 for video processing in accordance with some embodiments of the present disclosure. The method 3200 may be implemented during a conversion between a current video block of a video and a bitstream of the video. As shown in FIG. 32, the method 3200 starts at 3202, where a prediction for the current video block is determined based on a plurality of blending schemes. The current video block is coded with a first prediction mode comprising a geometric partitioning mode (GPM) based prediction mode or a combined inter and intra prediction (CIIP) based prediction mode, which will be described in details below.

The plurality of blending schemes are used for blending samples in a plurality of predictions associated with the current video block. In one example, the plurality of predictions associated with the current video block may comprise a plurality of candidate predictions for the current video block that are generated based on different prediction schemes. In another example, the current video block may be split into a plurality of partitions, such as two or more partitions. The plurality of predictions associated with the current video block may comprise predictions for the plurality of partitions. By way of example, with reference to FIG. 31A, the plurality of blending schemes may be used for blending prediction samples for partition 0 and partition 1. It should be understood that the above examples are described merely for purpose of description. The scope of the present disclosure is not limited in this respect.

In some embodiments, a target blending scheme is selected from the plurality of blending schemes. Furthermore, the prediction for the current video block is determined by blending the samples in the plurality of predictions associated with the current video block based on the target blending scheme.

In some further embodiments, a part of samples in the plurality of predictions may be blended based on one of the plurality of blending schemes, while a further part of samples in the plurality of predictions may be blended based on a further one of the plurality of blending schemes. The prediction for the current video block may be obtained by combining these blended parts. It should be understood that the prediction for the current video block may be determined based on the plurality of blending schemes in any other suitable manner. The scope of the present disclosure is not limited in this respect.

At 3204, the conversion is performed based on the determined prediction for the current video block. In one example, the conversion may include encoding the current video block into the bitstream. Alternatively or additionally, the conversion may include decoding the current video block from the bitstream.

In view of the above, the current video block is coded with a GPM based mode or a CIIP based mode, and a prediction for the current video block is determined based on a plurality of blending schemes. Compared with the convention solution where only one blending scheme is available, the proposed method can advantageously employ one or more of the plurality of blending schemes adaptively, and thus improve the coding quality.

In some embodiments, the current video block may be comprised in a current video unit of the video. By way of example rather than limitation, a video unit may be a sequence, a group of pictures, a picture, a slice, or the like. In one example embodiment, if a blending scheme in the plurality of blending schemes is used for current video unit, the blending scheme may be used for all blocks in the current video unit that are coded with a same prediction mode, such as the first prediction mode or the like. In this case, this blending scheme may also be regard as a target blending scheme for the current video unit.

By way of example rather than limitation, the target blending scheme used for the current video unit may be selected from the plurality of blending schemes based on at least one indication (such as syntax element(s) or the like) in the bitstream. Moreover, the prediction for the current video block may be determined based on the target blending scheme.

In some embodiments, the bitstream may comprise a first indication (such as syntax element(s) or the like) indicating at least one blending scheme in the plurality of blending schemes that is used for the current video block. For example, the first indication may be indicated at one of the following levels: a sequence parameter set (SPS) level, a picture parameter set (PPS) level, a picture header level, or a slice header level. It should be understood that the first indication may also be indicated at any other suitable level, and the scope of the present disclosure is not limited in this respect.

In some embodiments, the above-mentioned CIIP based prediction mode may comprise a CIIP mode, a CIIP-TM mode, a CIIP-MMVD mode, and/or any other suitable variants of the CIIP. In addition, the above-mentioned GPM based prediction mode may comprise a GPM mode, a spatial GPM (SGPM) mode, a GPM inter-intra mode, a GPM template matching (GPM-TM) mode, a GPM merge mode with motion vector difference (GPM-MMVD) mode, and/or any suitable variants of the GPM.

In some further embodiments, the GPM based prediction mode may comprise a prediction mode in which the current video block is geometrically split into a plurality of partitions, a prediction for one of the plurality of partitions is determined based on a first mode, and a prediction for a further one of the plurality of partitions is determined based on a second mode different from the first mode. Such a GPM based prediction mode may also be denoted as PredA-PredB-GPM, where PredA denotes the first mode and PredB denotes the second mode.

In one example, the first mode may comprise an inter mode, and the second mode may comprise an intra mode. In another example, the first mode may comprise a type of inter mode, and the second mode may comprise a further type of inter mode. In a further example, the first mode may comprise a type of intra luma mode, and the second mode may comprise a further type of intra luma mode.

Alternatively, the first mode may comprise a type of intra chroma mode, and the second mode may comprise a further type of intra chroma mode. In a still further example, the first mode may comprise an intra block copy (IBC) mode, and the second mode may comprise an intra mode. Alternatively, the first mode may comprise an IBC mode, and the second mode may comprise an inter mode. In a still further example, the first mode may comprise an intraTMP mode, and the second mode may comprise an inter mode. As used herein, the intraTMP mode may refer to a template matching based prediction mode for intra coding blocks. It should be understood that the possible combinations of the first mode and the second mode described here are merely illustrative and therefore should not be construed as limiting the present disclosure in any way.

In some embodiments, in a first blending scheme of the plurality of blending schemes, a value for a metric of a blending region of the current video block in a direction may be fixed. Values for samples in the blending region may be determined based on values for samples in the plurality of predictions.

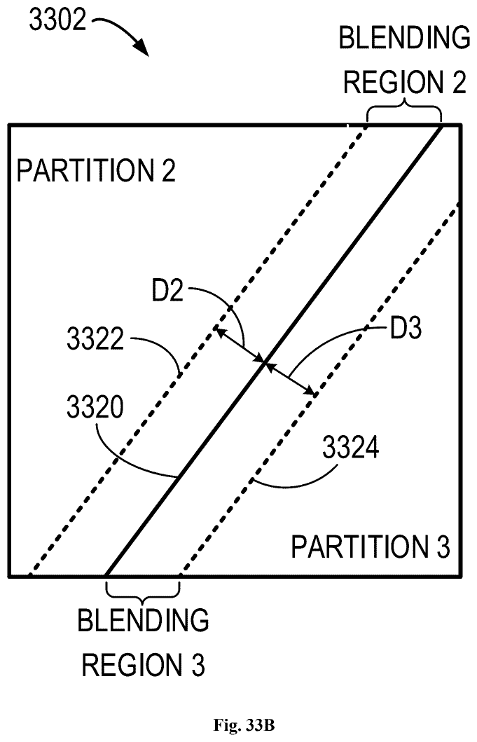

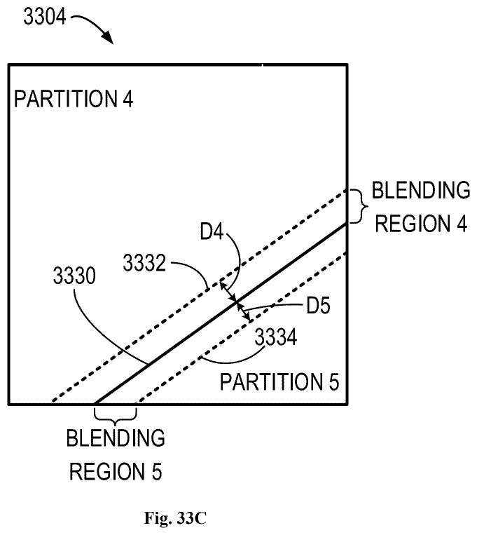

In some embodiments, the metric may be a width between two sides of the blending region, i.e., a distance between two sides of the blending region. For example, the metric may be in a direction perpendicular to the splitting line. This will be described in detail with reference to FIGS. 33A-33C. FIG. 33A illustrates an example of blending two partitions (i.e., partition 0 and partition 1) in accordance with embodiments of the present disclosure. The partition 0 and partition 1 are divided by the splitting line 3310. As shown in FIG. 33A, both of the two blending regions (i.e., blending region 0 and blending region 1) are rectangular. In such a case, the metric for the blending region 0 is denoted as D0, which corresponds to a width of the rectangular, i.e., a distance between the splitting line 3310 and line 3312. Similarly, the metric for the blending region 1 is denoted as D1, which corresponds to a width of the rectangular, i.e., a distance between the splitting line 3310 and line 3314. In some alternative embodiments, the two blending regions (i.e., blending region 0 and blending region 1) as a whole may be regard as a single blending region, and thus a sum of the widths D0 and D1 may be regard as the metric of the single blending region.

FIG. 33B illustrates a further example of blending two partitions (i.e., partition 2 and partition 3) in accordance with embodiments of the present disclosure. The partition 2 and partition 3 are divided by the splitting line 3320. As shown in FIG. 33B, blending region 2 is a parallelogram and blending region 3 is a pentagon. In such a case, the metric for the blending region 2 is denoted as D2, which corresponds to a height of the parallelogram, i.e., a distance between the splitting line 3320 and line 3322. The metric for the blending region 3 is denoted as D3, which corresponds to a distance between the splitting line 3320 and line 3324. It should be understood that D2 may also be referred to as a width of the blending region 2, and D3 may also be referred to as a width of the blending region 3. In some alternative embodiments, the two blending regions (i.e., blending region 2 and blending region 3) as a whole may be regard as a single blending region, and thus a sum of the widths D2 and D3 may be regard as the metric of the single blending region.

FIG. 33C illustrates a still further example of blending two partitions (i.e., partition 4 and partition 5) in accordance with embodiments of the present disclosure. The partition 4 and partition 5 are divided by the splitting line 3330. As shown in FIG. 33C, both of the two blending regions (i.e., blending region 4 and blending region 5) are trapezoid. In such a case, the metric for the blending region 4 is denoted as D4, which corresponds to a height of the trapezoid, i.e., a distance between the splitting line 3330 and line 3332. Similarly, the metric for the blending region 5 is denoted as D5, which corresponds to a height of the trapezoid, i.e., a distance between the splitting line 3330 and line 3334. It should be understood that D4 may also be referred to as a width of the blending region 4, and D5 may also be referred to as a width of the blending region 5. In some embodiments, the two blending regions (i.e., blending region 4 and blending region 5) as a whole may be regard as a single blending region, and thus a sum of the widths D4 and D5 may be regard as the metric of the single blending region.

It should be understood that the above illustrations and/or examples are described merely for purpose of description. The scope of the present disclosure is not limited in this respect.

In some embodiments, the value for the metric may be equal to a fixed value, such as ½ sample, 1 sample, 2 samples or the like.

In a case where the value for the metric is fixed and equal to ½ sample, if the current video block is split into a plurality of partitions vertically or horizontally (e.g., an angle index for a splitting line is equal to 0, 8, 16, or 24; or an angle for the splitting line is equal to 0°, 90°, 180°, or 270°), no blending may be applied for samples in the plurality of partitions. In addition, if the current video block is split into a plurality of partitions by an oblique splitting line (e.g., the angle index for the splitting line is not equal to 0, 8, 16 and 24; or the angle for the splitting line is not equal to 0°, 90°, 180°, and 270°), at least one piece of the following information associated with a first sample in the current video block may be dependent on a distance between the first sample and the splitting line: whether to blend sample values in the plurality of predictions to obtain a prediction value for the first sample, or how to blend sample values in the plurality of predictions to obtain a prediction value for the first sample. By way of example, if the distance between the sample and the splitting line is smaller than a threshold (such as ½ sample, 1 sample, or the like), the prediction value for the first sample may be obtained by blending sample values in the plurality of predictions.

In some embodiments, in a second blending scheme of the plurality of blending schemes, the value for the metric of the blending region of the current video block may be determined at an encoder and/or a decoder for coding the video. For example, the value for the metric may be determined based on coding information of the current video block and/or coding information of a block coded before the current video block. Different values for the metric may be used for different blocks coded with a same mode.

In one example embodiment, the coding information may comprise a block size. For example, if a size of the current video block is larger than a size of a further video block of the video, the value for the metric used for the current video block may be larger than a value for the metric used for the further video block. By way of example, a larger blending region width may be used for large blocks, while a smaller blending region width may be used for small blocks.

In an additional or alternative example embodiment, the coding information may comprise a height and a width. By way of example, if a smaller one of the height and the width of the current video block is equal to a first threshold in a set of thresholds, the value for the metric used for the current video block may be equal to a predetermined value corresponding to the first threshold. Additionally, if a smaller one of the height and the width of the current video block is different from each of the set of thresholds, the value for the metric used for the current video block may be equal to a further predetermined value. By way of example rather than limitation, the set of thresholds may comprise 4 samples, 8 samples, 16 samples, and 32 samples, and the corresponding blending region width is 1 sample, 2 samples, 3 samples, and 4 samples. Moreover, the further predetermined value may be 5 samples or the like. It should be understood that the specific values recited herein are intended to be exemplary rather than limiting the scope of the present disclosure.

In some alternative embodiments, the value for the metric may be determined based on a second indication (such as syntax element(s) or the like) in the bitstream. By way of example rather than limitation, the second indication may be a block-level index, i.e., an index signaled or coded at the block level.

In some further embodiments, the value for the metric may be determined based on a decoder side scheme, such as a template-cost-based decoder determination scheme or the like. For example, the value for the metric may be determined from a plurality of candidate values for the metric based on template costs. In addition, the plurality of candidate values may be predetermined.

In some embodiments, the current video block may be split into a plurality of partitions by a splitting line. Moreover, a weight for a prediction sample used for determining a prediction value for a sample in the current video block may be determined based on a distance between the sample and the splitting line.

In some embodiments, in a third blending scheme of the plurality of blending schemes, a set of weights for blending samples in a plurality of predictions may be predetermined. Additionally or alternatively, in a fourth blending scheme of the plurality of blending schemes, a set of weights for blending samples in a plurality of predictions may be determined at an encoder or a decoder. For example, the set of weights may be determined based on coding information of the current video block and/or coding information of a block coded before the current video block. By way of example, the coding information may comprise a block size, a quantization parameter, and/or the like.

In some embodiments, at least one candidate value for a metric of a blending region of the current video block in a direction that is allowed for an SGPM may be a subset of a plurality of candidate values for the metric that are allowed for a further GPM based prediction mode different form SGPM. By way of example rather than limitation, the further GPM based prediction mode may comprise a GPM, a GPM-TM, a GPM-MMVD, a GPM inter-intra, or any other suitable variants of GPM.

In some embodiments, the at least one candidate value for the metric that is allowed for an SGPM may comprise ½ sample, while the plurality of candidate values for the metric that are allowed for the further GPM based prediction mode may comprise ½ sample, 1 sample, and 2 samples. For example, the blending area widths allowed for a GPM coded block are {½, 1, 2, 4, 8} samples or {½, 1, 2} samples at each side from the splitting line, while the blending area width allowed for a SGPM coded block is equal to ½ sample.

In some embodiments, the at least one candidate value may comprise a minimum value in the plurality of candidate values. In some alternative embodiments, the bitstream may comprise a third indication (such as syntax element(s) or the like) indicating whether the at least one candidate value comprise a minimum value in the plurality of candidate values. For example, the third indication may be indicated at one of the following levels: an SPS level, a VPS level, a PPS level, a group of pictures level, a picture header, a picture level, a subpicture level, a slice header, a slice level, a group of tiles level, a tile level, or a brick level.

In some embodiments, a fourth indication (such as syntax element(s) or the like) indicating information regarding at least one of the following may be comprised in the bitstream at a PPS level: whether to generate samples around a splitting line of the current video block with a blending process, or how to generate samples around the splitting line with the blending process.

In some embodiments, a fifth indication (such as syntax element(s) or the like) may be comprised in the bitstream at a PPS level. The fifth indication indicates that samples around a splitting line of the current video block may be generated with a fixed value for the metric of the blending region of the current video block.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, a prediction for a current video block of the video is determined based on a plurality of blending schemes for blending samples in a plurality of predictions associated with the current video block. The current video block is coded with a first prediction mode comprising a geometric partitioning mode (GPM) based prediction mode or a combined inter and intra prediction (CIIP) based prediction mode. Moreover, the bitstream is generated based on the prediction.

According to still further embodiments of the present disclosure, a method for storing bitstream of a video is provided. In the method, a prediction for a current video block of the video is determined based on a plurality of blending schemes for blending samples in a plurality of predictions associated with the current video block. The current video block is coded with a first prediction mode comprising a geometric partitioning mode (GPM) based prediction mode or a combined inter and intra prediction (CIIP) based prediction mode. Moreover, the bitstream is generated based on the prediction, and stored in a non-transitory computer-readable recording medium.

Implementations of the present disclosure can be described in view of the following clauses, the features of which can be combined in any reasonable manner.
Clause 1. A method for video processing, comprising: determining, for a conversion between a current video block of a video and a bitstream of the video, a prediction for the current video block based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and performing the conversion based on the prediction.
Clause 2. The method of clause 1, wherein the current video block is comprised in a current video unit of the video.
Clause 3. The method of clause 2, wherein the current video unit comprises one of the following: a sequence, a group of pictures, a picture, or a slice.
Clause 4. The method of any of clauses 2-3, wherein the bitstream comprises a first indication indicating at least one blending scheme in the plurality of blending schemes that is used for the current video block.
Clause 5. The method of clause 4, wherein the first indication is indicated at one of the following levels: a sequence parameter set (SPS) level, a picture parameter set (PPS) level, a picture header level, or a slice header level.
Clause 6. The method of any of clauses 2-5, wherein if a blending scheme in the plurality of blending schemes is used for current video unit, the blending scheme is used for all blocks in the current video unit that are coded with the first prediction mode.
Clause 7. The method of any of clauses 1-6, wherein the GPM based prediction mode comprises at least one of the following: a GPM mode, a spatial GPM (SGPM) mode, a GPM inter-intra mode, a GPM template matching (GPM-TM) mode, or a GPM merge mode with motion vector difference (GPM-MMVD) mode.
Clause 8. The method of any of clauses 1-7, wherein the GPM based prediction mode comprises a prediction mode in which the current video block is geometrically split into a plurality of partitions, a prediction for one of the plurality of partitions is determined based on a first mode, and a prediction for a further one of the plurality of partitions is determined based on a second mode different from the first mode.
Clause 9. The method of clause 8, wherein the first mode comprises an inter mode, and the second mode comprises an intra mode, or the first mode comprises a type of inter mode, and the second mode comprises a further type of inter mode, or the first mode comprises a type of intra luma mode, and the second mode comprises a further type of intra luma mode, or the first mode comprises a type of intra chroma mode, and the second mode comprises a further type of intra chroma mode, or the first mode comprises an intra block copy (IBC) mode, and the second mode comprises an intra mode, or the first mode comprises an IBC mode, and the second mode comprises an inter mode, or the first mode comprises an intraTMP mode, and the second mode comprises an inter mode.
Clause 10. The method of any of clauses 1-9, wherein the CIIP based prediction mode comprises at least one of the following: a CIIP mode, a CIIP-TM mode, or a CIIP-MMVD mode.
Clause 11. The method of any of clauses 1-10, wherein in a first blending scheme of the plurality of blending schemes, a value for a metric of a blending region of the current video block in a direction is fixed, values for samples in the blending region being determined based on values for samples in the plurality of predictions.
Clause 12. The method of clause 11, wherein the value for the metric is equal to a fixed value.
Clause 13. The method of clause 12, wherein the fixed value is a ½ sample.
Clause 14. The method of any of clauses 11-13, wherein if the current video block is split into a plurality of partitions vertically or horizontally, no blending is applied for samples in the plurality of partitions.
Clause 15. The method of any of clauses 11-13, wherein if the current video block is split into a plurality of partitions by an oblique splitting line, at least one piece of the following information associated with a first sample in the current video block is dependent on a distance between the first sample and the splitting line: whether to blend sample values in the plurality of predictions to obtain a prediction value for the first sample, or how to blend sample values in the plurality of predictions to obtain a prediction value for the first sample.
Clause 16. The method of clause 15, wherein if the distance between the sample and the splitting line is smaller than a threshold, the prediction value for the first sample is obtained by blending sample values in the plurality of predictions.
Clause 17. The method of clause 16, wherein the threshold is ½ sample.
Clause 18. The method of any of clauses 1-17, wherein in a second blending scheme of the plurality of blending schemes, a value for a metric of a blending region of the current video block in a direction is determined at at least one of an encoder or a decoder, values for samples in the blending region being determined based on values for samples in the plurality of predictions.
Clause 19. The method of clause 18, wherein the value for the metric is determined based on coding information of the current video block or coding information of a block coded before the current video block.
Clause 20. The method of clause 19, wherein different values for the metric are used for different blocks coded with a same mode.
Clause 21. The method of any of clauses 19-20, wherein the coding information comprises a block size.
Clause 22. The method of clause 21, wherein if a size of the current video block is larger than a size of a further video block of the video, the value for the metric used for the current video block is larger than a value for the metric used for the further video block.
Clause 23. The method of any of clauses 19-20, wherein the coding information comprises a height and a width.
Clause 24. The method of clause 23, wherein if a smaller one of the height and the width of the current video block is equal to a first threshold in a set of thresholds, the value for the metric used for the current video block is equal to a predetermined value corresponding to the first threshold, or if a smaller one of the height and the width of the current video block is different from each of the set of thresholds, the value for the metric used for the current video block is equal to a further predetermined value.
Clause 25. The method of clause 18, wherein the value for the metric is determined based on a second indication in the bitstream.
Clause 26. The method of clause 25, wherein the second indication comprises a block-level index.
Clause 27. The method of clause 18, wherein the value for the metric is determined based on a decoder side scheme.
Clause 28. The method of clause 27, wherein the value for the metric is determined from a plurality of candidate values for the metric based on template costs.
Clause 29. The method of clause 28, wherein the plurality of candidate values are predetermined.
Clause 30. The method of any of clauses 18-29, wherein the current video block is split into a plurality of partitions by a splitting line, and a weight for a prediction sample used for determining a prediction value for a sample in the current video block is determined based on a distance between the sample and the splitting line.
Clause 31. The method of any of clauses 1-30, wherein in a third blending scheme of the plurality of blending schemes, a set of weights for blending samples in a plurality of predictions is predetermined.
Clause 32. The method of any of clauses 1-30, wherein in a fourth blending scheme of the plurality of blending schemes, a set of weights for blending samples in a plurality of predictions is determined at an encoder or a decoder.
Clause 33. The method of clause 32, wherein the set of weights is determined based on coding information of the current video block or coding information of a block coded before the current video block.
Clause 34. The method of any of clauses 2-3, wherein determining a prediction for the current video block comprises: selecting a target blending scheme used for the current video unit from the plurality of blending schemes based on at least one indication in the bitstream; and determining the prediction for the current video block based on the target blending scheme.
Clause 35. The method of any of clauses 1-18, wherein at least one candidate value for a metric of a blending region of the current video block in a direction that is allowed for an SGPM is a subset of a plurality of candidate values for the metric that are allowed for a further GPM based prediction mode different form SGPM.
Clause 36. The method of clause 35, wherein the further GPM based prediction mode comprises one of a GPM, a GPM-TM, a GPM-MMVD, or a GPM inter-intra.
Clause 37. The method of any of clauses 35-36, wherein the at least one candidate value comprises ½ sample, and the plurality of candidate values comprises ½ sample, 1 sample, and 2 samples.
Clause 38. The method of any of clauses 35-36, wherein the at least one candidate value comprises a minimum value in the plurality of candidate values.
Clause 39. The method of any of clauses 35-36, wherein the bitstream comprises a third indication indicating whether the at least one candidate value comprises a minimum value in the plurality of candidate values.
Clause 40. The method of clause 39, wherein the third indication is indicated at one of the following levels: an SPS level, a VPS level, a PPS level, a group of pictures level, a picture header, a picture level, a subpicture level, a slice header, a slice level, a group of tiles level, a tile level, or a brick level.
Clause 41. The method of any of clauses 1-40, wherein a fourth indication indicating information regarding at least one of the following is comprised in the bitstream at a PPS level: whether to generate samples around a splitting line of the current video block with a blending process, or how to generate samples around the splitting line with the blending process.
Clause 42. The method of any of clauses 1-41, wherein a fifth indication is comprised in the bitstream at a PPS level, the fifth indication indicating that samples around a splitting line of the current video block is generated with a fixed value for a metric of a blending region of the current video block in a direction, values for samples in the blending region may be determined based on values for samples in the plurality of predictions.
Clause 43. The method of any of clauses 11-42, wherein the metric is a width between two sides of the blending region.
Clause 44. The method of any of clauses 1-43, wherein the conversion includes encoding the current video block into the bitstream.
Clause 45. The method of any of clauses 1-43, wherein the conversion includes decoding the current video block from the bitstream.
Clause 46. An apparatus for video processing comprising a processor and a non-transitory memory with instructions thereon, wherein the instructions upon execution by the processor, cause the processor to perform a method in accordance with any of clauses 1-45.
Clause 47. A non-transitory computer-readable storage medium storing instructions that cause a processor to perform a method in accordance with any of clauses 1-45.
Clause 48. A non-transitory computer-readable recording medium storing a bitstream of a video which is generated by a method performed by an apparatus for video processing, wherein the method comprises: determining a prediction for a current video block of the video based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and generating the bitstream based on the prediction.
Clause 49. A method for storing a bitstream of a video, comprising: determining a prediction for a current video block of the video based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; generating the bitstream based on the prediction; and storing the bitstream in a non-transitory computer-readable recording medium.

### Example Device

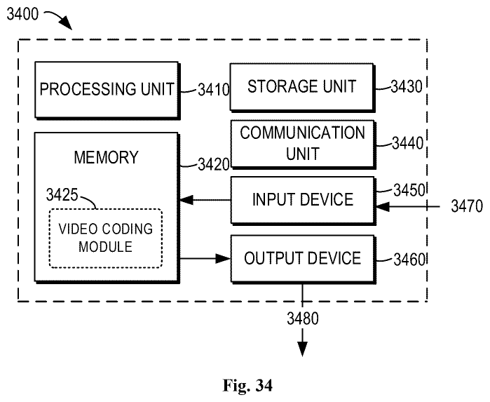

FIG. 34 illustrates a block diagram of a computing device 3400 in which various embodiments of the present disclosure can be implemented. The computing device 3400 may be implemented as or included in the source device 110 (or the video encoder 114 or 200) or the destination device 120 (or the video decoder 124 or 300).

It would be appreciated that the computing device 3400 shown in FIG. 34 is merely for purpose of illustration, without suggesting any limitation to the functions and scopes of the embodiments of the present disclosure in any manner.

As shown in FIG. 34, the computing device 3400 includes a general-purpose computing device 3400. The computing device 3400 may at least comprise one or more processors or processing units 3410, a memory 3420, a storage unit 3430, one or more communication units 3440, one or more input devices 3450, and one or more output devices 3460.

In some embodiments, the computing device 3400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3400 can support any type of interface to a user (such as “wearable” circuitry and the like).

The processing unit 3410 may be a physical or virtual processor and can implement various processes based on programs stored in the memory 3420. In a multi-processor system, multiple processing units execute computer executable instructions in parallel so as to improve the parallel processing capability of the computing device 3400. The processing unit 3410 may also be referred to as a central processing unit (CPU), a microprocessor, a controller or a microcontroller.

The computing device 3400 typically includes various computer storage medium. Such medium can be any medium accessible by the computing device 3400, including, but not limited to, volatile and non-volatile medium, or detachable and non-detachable medium. The memory 3420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3430 may be any detachable or non-detachable medium and may include a machine-readable medium such as a memory, flash memory drive, magnetic disk or another other media, which can be used for storing information and/or data and can be accessed in the computing device 3400.

The computing device 3400 may further include additional detachable/non-detachable, volatile/non-volatile memory medium. Although not shown in FIG. 34, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3440 communicates with a further computing device via the communication medium. In addition, the functions of the components in the computing device 3400 can be implemented by a single computing cluster or multiple computing machines that can communicate via communication connections. Therefore, the computing device 3400 can operate in a networked environment using a logical connection with one or more other servers, networked personal computers (PCs) or further general network nodes.

The input device 3450 may be one or more of a variety of input devices, such as a mouse, keyboard, tracking ball, voice-input device, and the like. The output device 3460 may be one or more of a variety of output devices, such as a display, loudspeaker, printer, and the like. By means of the communication unit 3440, the computing device 3400 can further communicate with one or more external devices (not shown) such as the storage devices and display device, with one or more devices enabling the user to interact with the computing device 3400, or any devices (such as a network card, a modem and the like) enabling the computing device 3400 to communicate with one or more other computing devices, if required. Such communication can be performed via input/output (I/O) interfaces (not shown).

In some embodiments, instead of being integrated in a single device, some or all components of the computing device 3400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3400 may be used to implement video encoding/decoding in embodiments of the present disclosure. The memory 3420 may include one or more video coding modules 3425 having one or more program instructions. These modules are accessible and executable by the processing unit 3410 to perform the functionalities of the various embodiments described herein.

In the example embodiments of performing video encoding, the input device 3450 may receive video data as an input 3470 to be encoded. The video data may be processed, for example, by the video coding module 3425, to generate an encoded bitstream. The encoded bitstream may be provided via the output device 3460 as an output 3480.

In the example embodiments of performing video decoding, the input device 3450 may receive an encoded bitstream as the input 3470. The encoded bitstream may be processed, for example, by the video coding module 3425, to generate decoded video data. The decoded video data may be provided via the output device 3460 as the output 3480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a prediction for the current video block based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and
performing the conversion based on the prediction.

2. The method of claim 1, wherein the current video block is comprised in a current video unit of the video.

3. The method of claim 2, wherein the current video unit comprises one of the following: a sequence, a group of pictures, a picture, or a slice, or
wherein the bitstream comprises a first indication indicating at least one blending scheme in the plurality of blending schemes that is used for the current video block, or
wherein if a blending scheme in the plurality of blending schemes is used for current video unit, the blending scheme is used for all blocks in the current video unit that are coded with the first prediction mode.

4. The method of claim 1, wherein the GPM based prediction mode comprises at least one of the following: a GPM mode, a spatial GPM (SGPM) mode, a GPM inter-intra mode, a GPM template matching (GPM-TM) mode, or a GPM merge mode with motion vector difference (GPM-MMVD) mode.

5. The method of claim 1, wherein the GPM based prediction mode comprises a prediction mode in which the current video block is geometrically split into a plurality of partitions, a prediction for one of the plurality of partitions is determined based on a first mode, and a prediction for a further one of the plurality of partitions is determined based on a second mode different from the first mode.

6. The method of claim 5, wherein the first mode comprises an inter mode, and the second mode comprises an intra mode, or
the first mode comprises a type of inter mode, and the second mode comprises a further type of inter mode, or
the first mode comprises a type of intra luma mode, and the second mode comprises a further type of intra luma mode, or
the first mode comprises a type of intra chroma mode, and the second mode comprises a further type of intra chroma mode, or
the first mode comprises an intra block copy (IBC) mode, and the second mode comprises an intra mode, or
the first mode comprises an IBC mode, and the second mode comprises an inter mode, or
the first mode comprises an intraTMP mode, and the second mode comprises an inter mode.

7. The method of claim 1, wherein in a first blending scheme of the plurality of blending schemes, a value for a metric of a blending region of the current video block in a direction is fixed, values for samples in the blending region being determined based on values for samples in the plurality of predictions.

8. The method of claim 1, wherein in a second blending scheme of the plurality of blending schemes, a value for a metric of a blending region of the current video block in a direction is determined at at least one of an encoder or a decoder, values for samples in the blending region being determined based on values for samples in the plurality of predictions.

9. The method of claim 8, wherein the value for the metric is determined based on coding information of the current video block or coding information of a block coded before the current video block.

10. The method of claim 1, wherein in a third blending scheme of the plurality of blending schemes, a set of weights for blending samples in a plurality of predictions is predetermined, or
wherein in a fourth blending scheme of the plurality of blending schemes, a set of weights for blending samples in a plurality of predictions is determined at an encoder or a decoder.

11. The method of claim 2, wherein determining a prediction for the current video block comprises:
selecting a target blending scheme used for the current video unit from the plurality of blending schemes based on at least one indication in the bitstream; and
determining the prediction for the current video block based on the target blending scheme.

12. The method of claim 1, wherein at least one candidate value for a metric of a blending region of the current video block in a direction that is allowed for an SGPM is a subset of a plurality of candidate values for the metric that are allowed for a further GPM based prediction mode different form SGPM.

13. The method of claim 12, wherein the further GPM based prediction mode comprises one of a GPM, a GPM-TM, a GPM-MMVD, or a GPM inter-intra, or
wherein the at least one candidate value comprises ½ sample, and the plurality of candidate values comprises ½ sample, 1 sample, and 2 samples.

14. The method of claim 1, wherein a fourth indication indicating information regarding at least one of the following is comprised in the bitstream at a PPS level: whether to generate samples around a splitting line of the current video block with a blending process, or how to generate samples around the splitting line with the blending process, or
wherein a fifth indication is comprised in the bitstream at a PPS level, the fifth indication indicating that samples around a splitting line of the current video block is generated with a fixed value for a metric of a blending region of the current video block in a direction, values for samples in the blending region may be determined based on values for samples in the plurality of predictions.

15. The method of claim 7, wherein the metric is a width between two sides of the blending region.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
determining, for a conversion between a current video block of a video and a bitstream of the video, a prediction for the current video block based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and
performing the conversion based on the prediction.

19. A non-transitory computer-readable storage medium storing instructions that cause a processor to perform acts comprising:
determining, for a conversion between a current video block of a video and a bitstream of the video, a prediction for the current video block based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and
performing the conversion based on the prediction.

20. A non-transitory computer-readable recording medium storing a bitstream of a video which is generated by a method performed by an apparatus for video processing, wherein the method comprises:
determining a prediction for a current video block of the video based on a plurality of blending schemes for blending samples in a plurality of predictions associated with the current video block, wherein the current video block is coded with a first prediction mode comprising a geometric partitioning mode (GPM) based prediction mode or a combined inter and intra prediction (CIIP) based prediction mode; and
generating the bitstream based on the prediction.
